(19) United States
(12) Patent Application Publication
(10) Pub. No.: US 2026/0290368 A1
(43) Pub. Date: Sep. 24, 2026

(54) Generating Customized Audio

(71) Applicant: Bettear Accessible Technologies Development Ltd, TEL AVIV-JAFFA (IL)

(72) Inventors: Nir Fink, Hod Hasharon (IL); Yami Thor, Gat Rimon (IL); Itamar Gabbay, Tel-Aviv (IL); Yossi Bar-Yoseph, Hod Hasharon (IL)

(21) Appl. No.: 19/477,388

(22) PCT Filed: Apr. 22, 2024
(86) PCT No.: PCT/IL2024/050403

§ 371 Date: Oct. 21, 2025

Related U.S. Application Data
(60) Provisional application No. 63/497,728, filed on Apr. 23, 2023.

(51) Int. Cl. G10L 21/047; G10L 21/0272; G10L 21/057

(52) U.S. Cl. CPC G10L 21/047; G10L 21/0272; G10L 21/057

(57) ABSTRACT

A method, system and product comprising: capturing an audio signal from an audio source; processing the audio signal based on a population segment by: obtaining a target speech rate for the population segment, the target speech rate is a rate of speech that is deemed suitable to estimated hearing capabilities of members of the population segment; and adjusting the audio signal according to the target speech rate for the population segment, thereby obtaining an adjusted audio signal that matches the hearing capabilities of the population segment; and providing the adjusted audio signal to an end device to be served to a user, wherein the population segment comprises the user, the user is using the end device to consume audio.

### CROSS-REFERENCE TO RELATED APPLICATION

This application claims the benefit of Provisional Patent Application No. 63/497,728, entitled “Method, Product and System for Generating Accessible Audio”, filed Apr. 23, 2023, which is hereby incorporated by reference in its entirety without giving rise to disavowment.

### TECHNICAL FIELD

The present disclosure relates to audio generation in general, and to adaptively processing audio according to population segments, in particular.

### BACKGROUND

The prevalence of hearing impairment affects the daily lives of millions, with social implications ranging from communication barriers to diminished opportunities. This issue extends beyond mere auditory limitations, as it has been increasingly recognized for its broader impact on mental health and cognitive function. Studies have underscored the association between hearing difficulties and the heightened risk of developing mental health disorders, including depression and anxiety, as well as conditions like dementia.

Traditional interventions, such as conventional hearing aids, have been instrumental in ameliorating the effects of hearing impairment. These devices can make a nearby sound audible to a person with hearing loss or hearing degradation. However, conventional hearing aids are often characterized by a one-size-fits-all approach, failing to fully accommodate the diverse needs in day-to-day settings of users. For example, conventional hearing aids may not necessarily improve the listening experience of users in a wide range of settings, lifestyles, and environmental contexts, effectively function properly for remote sound sources, or the like.

### BRIEF SUMMARY

One exemplary embodiment of the disclosed subject matter is a method comprising: capturing an audio signal from an audio source; processing the audio signal based on a population segment, said processing comprises: obtaining a target speech rate for the population segment, the target speech rate is a rate of speech that is deemed suitable to estimated hearing capabilities of members of the population segment; and adjusting the audio signal according to the target speech rate for the population segment, thereby obtaining an adjusted audio signal that matches the hearing capabilities of the population segment; and providing the adjusted audio signal to an end device to be served to a user, wherein the population segment comprises the user, the user is using the end device to consume audio.

Optionally, said processing further comprises separating the audio signal into a plurality of acoustic components, wherein the plurality of acoustic components comprises at least two of: a speech component, a music component, and a sound effect component.

Optionally, said adjusting comprises adjusting the speech component according to the target speech rate.

Optionally, said processing further comprises: balancing weights of the plurality of acoustic components according to preferences of the population segment, thereby obtaining the adjusted audio signal.

Optionally, the preferences are associated with at least one of: a vocals-to-non-vocals ratio, a dynamic loudness range, and a level of attenuation of background noise.

Optionally, said adjusting is performed with a first time-lag threshold if said processing comprises offline processing, and with a second time-lag threshold if said processing comprises real-time processing, the first and second time-lag thresholds are different.

Optionally, the method further comprises reducing a latency created by said adjusting the audio signal according to the target speech rate, wherein said reducing the latency comprises: accelerating a pace of a first non-speech segment of the audio signal, removing a second non-speech segment of the audio signal, or the like.

Optionally, the target speech rate is slower than an original speech rate of the audio signal.

Optionally, said processing further comprises classifying content of the audio signal to an auditory scene, wherein the auditory scene comprises at least one of: a conversation, a lecture, a defined movie scene, music, a live performance, aircraft sounds, construction sounds, nature sounds, train sounds, and vehicle sounds.

Optionally, said adjusting is performed based on the auditory scene, wherein the target speech rate for the population segment is configured to match the hearing capabilities of the population segment for the auditory scene.

Optionally, said capturing the audio signal comprises receiving the audio signal from a console or a mixer associated with the audio source.

Optionally, said capturing the audio signal comprises recording a sound produced by the audio source.

Optionally, the method further comprising classifying the user to the population segment.

Optionally, said classifying is based on demographic information of the user, the demographic information comprising at least one of: an age range, a type of hearing impairment, a gender, a cognitive state, and an attention disorder.

Optionally, the demographic information is provided by the user via a user interface of a dedicated software application presented on the end device.

Optionally, the demographic information is determined indirectly based on data of the end device.

Optionally, said providing the adjusted audio signal is performed via Application Programming Interface (API) calls of a third-party software application executed on the end device.

Optionally, said providing the adjusted audio signal is performed via a communication medium selected from: Low Energy (LE)-audio, long range wireless communications, Infrared communications, Type-C communications, Bluetooth™, Auracast™, short range wireless communications, Lightning™, cellular communications, wired communications, WIFI™, or the like.

Optionally, the audio source comprises an audio source of at least one of: a cinema, a theater, a television, a person participating in a conversation with the user, or the like.

Optionally, the end device comprises at least one device selected from: a smartphone, a smart television, a mobile device, a laptop, hearables, Personal Computer (PC), wearables, a tablet, or the like.

Optionally, said processing is performed at least in part by at least one of: a central processing unit, and the end device.

Optionally, the method is performed in an environment, wherein the user is present in the environment, wherein the user is using the end device to consume audio in the environment, wherein said capturing comprises capturing the audio signal in the environment.

Optionally, the method further comprises processing the audio signal based on a second population segment, the second population segment comprises a second user with a second end device, said processing comprises: obtaining a second speech rate for the second population segment, the second speech rate is a rate of speech that is deemed suitable to estimated hearing capabilities of members of the second population segment; adjusting the audio signal according to the second speech rate for the second population segment, thereby obtaining a second adjusted audio signal that matches the hearing capabilities of the second population segment; and providing the second adjusted audio signal to the second end device, to be served to the second user.

Another exemplary embodiment of the disclosed subject matter is a computer program product comprising a non-transitory computer readable storage medium retaining program instructions, which program instructions when read by a processor, cause the processor to: capture an audio signal from the audio source; process the audio signal based on a population segment, said process comprises: obtain a target speech rate for the population segment, the target speech rate is a rate of speech that is deemed suitable to estimated hearing capabilities of members of the population segment; and adjust the audio signal according to the target speech rate for the population segment, thereby obtaining an adjusted audio signal that matches the hearing capabilities of the population segment; and provide the adjusted audio signal to an end device to be served to a user, wherein the population segment comprises the user, the user is using the end device to consume audio.

Yet another exemplary embodiment of the disclosed subject matter is a system comprising a processor, an audio source, and coupled memory, the processor being adapted to: capture an audio signal from the audio source; process the audio signal based on a population segment, said process comprises: obtain a target speech rate for the population segment, the target speech rate is a rate of speech that is deemed suitable to estimated hearing capabilities of members of the population segment; and adjust the audio signal according to the target speech rate for the population segment, thereby obtaining an adjusted audio signal that matches the hearing capabilities of the population segment; and provide the adjusted audio signal to an end device to be served to a user, wherein the population segment comprises the user, the user is using the end device to consume audio.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 depicts an exemplary flowchart diagram, in accordance with some exemplary embodiments of the disclosed subject matter;

FIG. 2 depicts an exemplary schematic block diagram, in accordance with some exemplary embodiments of the disclosed subject matter;

FIG. 3A depicts an exemplary source separation process, in accordance with some exemplary embodiments of the disclosed subject matter;

FIG. 3B shows an exemplary process of audio content classification, in accordance with some exemplary embodiments of the disclosed subject matter;

FIGS. 4A and 4B depict exemplary schematic block diagrams, in accordance with some exemplary embodiments of the disclosed subject matter;

FIG. 5 depicts an exemplary Adaptive Speech Rate (ASR) module, in accordance with some exemplary embodiments of the disclosed subject matter;

FIG. 6 depicts an exemplary schematic block diagram, in accordance with some exemplary embodiments of the disclosed subject matter;

FIG. 7 depicts an exemplary process of adapting a speech rate, in accordance with some exemplary embodiments of the disclosed subject matter;

FIG. 8A depicts a schematic illustration of an exemplary scenario in which the disclosed subject matter may be utilized, in accordance with some exemplary embodiments of the disclosed subject matter; and

FIG. 8B shows exemplary hearing statistics, in accordance with some exemplary embodiments of the disclosed subject matter.

### DETAILED DESCRIPTION

One technical problem dealt with by the disclosed subject matter is personalizing audio content that is consumed by users. For example, it may be desired to enable users to customize their listening experience, according to their individual hearing capabilities and preferences.

In some exemplary embodiments, a user may be situated within an environment with one or more emitted sounds that the user may wish to hear in a customized manner (referred to as the ‘target sound’). For example, the sounds may be emitted within the environment, or provided to a device within the environment. In some exemplary embodiments, the user may have a user device, such as a smartphone, a mobile device, a laptop, a hearing device, or the like. In some exemplary embodiments, the user may wear a hearing device such as a hearing assistive device, hearables, earbuds, a user device with speakers for serving audio to the user, or the like. In some exemplary embodiments, the user may desire to consume, via the hearing device and/or the user device, a processed version of the target sound that is tailored to their preferences. For example, the user may watch a visual media production such as movie and desire to hear the movie's soundtrack, the user may converse with a friend and desire to hear the friend's voice, the user may participate in an online video-conference, the user may attend a theater performance and desire to hear the theater's soundtrack, or the like. According to this example, the user may wish to hear a processed version of the target sound, such as a version with a lower speech rate than the original target sound, a version with a certain vocals-to-non-vocals ratio that is different from the original ratio in the target sound, or any other adjustments to aspects of the audio. In a different scenario, the user may not wish to hear the target sound from his own user device, and instead may wish to hear the target sound from a third party or public device, e.g., from a public television, speakers, or the like.

In some exemplary embodiments, a naïve solution may comprise to utilize conventional hearing assistive devices for consuming a processed version of the target sound. In some exemplary embodiments, conventional hearing assistive devices such as hearing aid devices may be designed for improving hearing and communication abilities of individuals. In some exemplary embodiments, conventional hearing assistive devices may be configured to amplify sounds in a user's environment and make them more audible to the user. For example, hearing aid devices may capture sounds using a microphone, convert them into electrical signals, amplify the signals, convert the amplified signals back into sound waves, and deliver them into the user's ear. In some exemplary embodiments, although conventional hearing assistive devices may be helpful in some scenarios, they may have one or more drawbacks.

In some cases, hearing assistive devices may not fully cater to the complete hearing requirements and needs of users, as indicated by Dillon H, Day J, Bant S, Munro K J. Adoption, use and non-use of hearing aids: a robust estimate based on Welsh national survey statistics. Int J Audiol. 2020 August; 59 (8): 567-573. doi: 10.1080/14992027.2020.1773550. Epub 2020 Jun. 12. PMID: 32530329, which is hereby incorporated by reference in its entirety without giving rise to disavowment. In some exemplary embodiments, the study found that 20% of individuals provided with hearing aids do not utilize them, 30% use them intermittently, and the remaining 50% rely on their hearing aids most of the time. In some exemplary embodiments, conventional hearing aids may focus primarily on amplifying the entire audio signal and equalizing the sound to accommodate the listener's hearing patterns, rather than allowing users to adjust specific audio characteristics to match their preferences. In some cases, hearing assistive devices may not enable users to customize the listening experience properly according to hearing constraints, requirements per situation, preferences per situation, or the like (referred to hereinafter as ‘hearing capabilities’ and/or ‘hearing preferences’), such as by setting a desired vocals-to-non-vocals ratio of a song, a desired dynamic loudness range, a desired speech rate, or the like. It may be desired to overcome such drawbacks, and provide users with a listening experience (e.g., an audio mixture) that matches their hearing capabilities and personal preferences.

Another technical problem dealt with by the disclosed subject matter is personalizing audio for one or more defined population segments (also referred to as ‘user segments’). For example, it may be desired to produce listening experiences that match estimated hearing capabilities and preferences of population segments, e.g., with or without requiring users that belong to such population segments to directly define their hearing capabilities and preferences.

Yet another technical problem dealt with by the disclosed subject matter is personalizing synthetic audio to users, population segments, or the like.

In some exemplary embodiments, synthetic audio may comprise real-time content, which is captured and streamed in real time, or offline content such as a pre-loaded movie provided via a Video On Demand (VOD) system. In some exemplary embodiments, sound technicians may typically calibrate audio systems for the majority of listeners, but this may not accommodate individuals with specific hearing requirements. For example, synthetic audio may be produced by sound systems that may be configured by sound technicians with normal or average hearing, who may be trained to calibrate audio systems for delivering audio content suitable for the majority of individuals without specific hearing requirements.

In some exemplary embodiments, population segments that deviate from the majority in their hearing capabilities or preferences, may struggle with hearing and understanding the audio content of the audio systems. In some cases, factors that may reduce the audibility of the audio content include a high rate of speech (e.g., fast-talking audio content), background sound effects, background noise, a significant variation in the volume levels of the audio (e.g., a wide loudness range), a certain frequency of the speech, or the like. It may be desired to overcome such drawbacks, and enable population segments that deviate from the majority in their hearing capabilities or preferences to hear synthetic audio in a manner that matches their hearing capabilities and/or preferences.

Yet another technical problem dealt with by the disclosed subject matter is enhancing the listening experience of users, e.g., increasing an audibility of sounds provided to users when provided from a remote source.

In some cases, hearing assistive devices may be incapable of adequately improving perception of individual sounds for a user. For example, conventional hearing aid devices may function in a sub-optimal manner in case the microphones of the conventional hearing aid devices are distant from a source of sound, obstructed from the source of sound, or the like. For example, in case of a distance sound source, such as remote soundtrack speakers of a cinema, sounds from Public Announcement (PA) systems, amplified live music, or the like, conventional hearing aid devices may not differentiate well between background noise and the target sound, and may not provide an audible version of the target sound. In some exemplary embodiments, it may be desired to overcome these drawbacks, and provide users with clearer, more accessible audio experiences of a remote target sound.

One technical solution provided by the disclosed subject matter comprises processing audio content from an audio source according to hearing capabilities or preferences of different users, population segments, or the like. In some exemplary embodiments, the audio content may be adapted to the listeners' needs, such as based on real-time capturing, processing, and streaming of audio content, based on offline processing of audio content, or the like.

In some exemplary embodiments, one or more audio channels from an audio source may be captured. For example, the audio channels may be captured continuously, periodically, or the like. In some exemplary embodiments, the audio channels may be captured or obtained via a port or interface of an audio source, such as a console, a mixer, a channel separator, or the like. In some exemplary embodiments, the audio channels may be captured by one or more microphones. For example, the audio source may emit a sound into an environment, and the microphones may be configured to capture the emitted audio sound.

In some exemplary embodiments, the captured audio channels may be processed, e.g., according to hearing capabilities and needs of one or more population segments, users, or the like. In some exemplary embodiments, the captured audio channels may be adapted and customized in real-time, offline, or the like. In some exemplary embodiments, processing the captured audio channels may comprise adjusting one or more acoustic or audio parameters of the captured audio channels, applying filters thereon, applying masks thereon, or the like. For example, processing the captured audio channels may comprise adjusting acoustic and audio parameters such as a vocals-to-non-vocals ratio of a song, a dynamic loudness range, a level of attenuation of background noise, a speech rate, or the like.

In some exemplary embodiments, two or more population segments, clusters, or the like, may be defined, predefined, or the like. In some cases, determined population segments may comprise ranges of age groups, degrees of hearing loss, attention disorders such as Attention Deficit Disorder (ADD) or Attention Deficit Hyperactivity Disorder (ADHD), cognitive decline, sex, gender, or the like.

In some exemplary embodiments, one or more end users may be classified, or clustered, to one or more respective population segments, e.g., based on user properties such as their age group, type of hearing impairment, attention disorder, cognitive state, sex, gender, or the like. In some exemplary embodiments, user properties may be collected from end users directly, such as via a registration form of page of a dedicated software application or interface on end devices of users, via a user interface of a processing unit external to end devices of users, or the like. As an example, a user may provide personal information via a user interface of a dedicated application, and the personal information may be used to classify the user to a respective population segment. In some exemplary embodiments, user properties may be collected from end users indirectly, such as based on obtained user profiles, based on dynamically determined user profiles, based on user settings in one or more third party applications in the end device, based on detected hearing capabilities of the user, based on detected behavior of the user via the end device, or the like.

In some exemplary embodiments, for each population segment, different hearing capabilities and requirements may be defined, determined, set, or the like, e.g., directly, indirectly, or the like. In some exemplary embodiments, population segments may be matched to certain hearing capabilities and requirements of users (also referred to as ‘target hearing settings’) based on self-reporting of the end users. For example, a crowd-sourcing process may collect reported hearing settings that are set by each user, e.g., via a dedicated software application, and determine based thereon rules that are statistically significant for each population segment. In some cases, target hearing settings may comprise hearing capabilities of the user in different scenarios, e.g., a minimal amplitude level required for the users to understand a whisper audio signal, a maximal amplitude level allowing users to understand a shouting audio signal without annoyance, a Singer-to-Music ratio that is acceptable for the users, a maximal speech rate that is acceptable to the users, or the like.

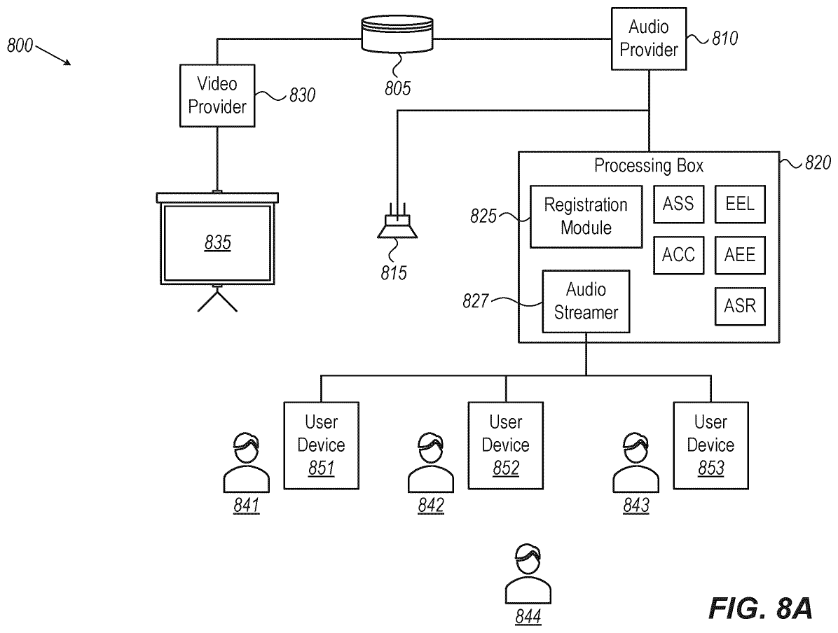

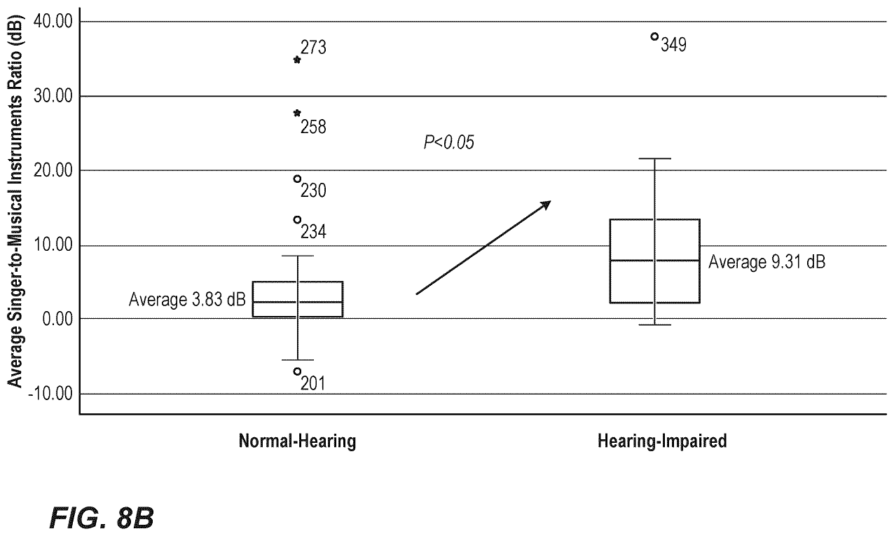

In some exemplary embodiments, population segments may be matched to certain hearing capabilities and requirements indirectly, such as based on statistics from FIG. 8B. In some exemplary embodiments, each population segment may correspond to at least one predetermined hearing capability, incapability, or the like. For example, a population segment may be determined to correspond to users that have specific hearing needs, e.g., a minimal amplitude level required for the users to understand a whisper audio signal, a maximal amplitude level allowing users to understand a shouting audio signal without annoyance, a Singer-to-Music ratio that is acceptable for the users, a maximal speech rate that is acceptable to the users, or the like.

In some exemplary embodiments, after classifying an end user to a specific user segment, the user's hearing settings may be automatically configured to correspond to the hearing capabilities and requirements that were matched to the user segment. In some cases, users may be presented with these hearing configurations as a starting point that may be adjusted or customized by the user to reflect the users' preferences. In other cases, users may be presented with baseline hearing configurations that reflect initial default preferences (e.g., normal hearing capabilities, average hearing capabilities of hearing impaired, or the like), regardless of their user segment, as a starting point that can be manually adjusted by the users to reflect the users' preferences.

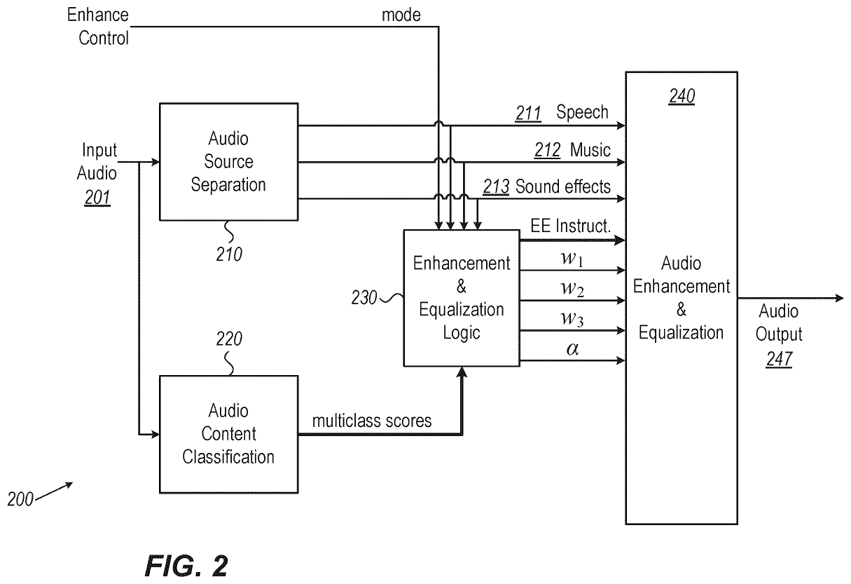

In some exemplary embodiments, the captured audio channels may be processed to match different user segments, individual hearing settings, or the like. In some exemplary embodiments, processing the captured audio channels may comprise separating the captured audio into different channels that represent different types of sound. For example, in case the captured audio channels are not separated already into different types of sound, the captured audio channels may be processed and separated into acoustic components such as a speech portion, a music portion, a sound effect portion, or the like, e.g., as performed by Audio Source Separation (ASS) Module 210 of FIG. 2.

In some exemplary embodiments, processing the captured audio channels may comprise classifying audio content, e.g., as performed by Audio Content Classifier (ACC) Module 220 of FIG. 2. For example, the captured audio channels may be classified to as a conversation, a lecture, a live performance, one or more types of movie scenes, or the like. In some cases, the classification of the audio content may be referred to as an auditory scene classification process.

In some exemplary embodiments, processing the captured audio channels may comprise adjusting one or more acoustic or audio parameters of the captured audio channels, applying filters thereon, applying masks thereon, or the like. For example, processing the captured audio channels may comprise adjusting weights of different acoustic components, adjusting a speech rate of a speech acoustic component, adjusting a vocals-to-non-vocals ratio, adjusting a dynamic loudness range, adjusting a level of attenuation of background noise, or the like.

In some exemplary embodiments, the captured audio channels may be adjusted to match one or more user segments, user settings, or the like. For example, users may indicate that they are interested in obtaining a processed version of the audio, e.g., in case the location of their end device is within a geofence associated with the target sound, by selecting a location or other setting directly, or the like. According to this example, the captured audio channels may be adjusted to match all user segments that are marked as relevant to the target sound. In other cases, the captured audio channels may be adjusted to match all defined user segments, e.g., regardless of any indication or presence marking. In some cases, the captured audio channels may be generated for user segments, and any adjustments to the acoustic settings may be applied locally on each end device. In other cases, the captured audio channels may be generated for all adjustments to the acoustic settings of relevant users (e.g., within the geofence).

For example, the captured audio channels may be processed by adjusting a ratio, or weight, of two or more signals within the received input audio. For example, the generation of the accessible audio may comprise identifying a signal of interest within the input audio, such as a speech, as opposed to music, sound effects, and background signals, and adjusting the weight of the signal of interest with respect to one or more other signals in the captured audio channels. In some exemplary embodiments, the signal of interest may comprise a speech, a sound effect, a musical instrument, or any other type of acoustic signal. For example, a ratio between a signal of vocal singer and a signal of the music instrument may be adjusted. In some cases, the adjustment may be performed according to the target hearing settings, e.g., user segment settings, approximately reflecting the listener's ability to comprehend such audio without annoyance.

As another example, the captured audio channels may be processed by adjusting a dynamic range level thereof. For example, a speech acoustic component may be identified in the captured audio channels, and a dynamic range level of the speech acoustic component may be adjusted according to target hearing settings, settings of one or more user segments, or the like.

As another example, the captured audio channels may be processed by adjusting a speech rate of a speech acoustic component. For example, a speech rate of an identified speech acoustic component may be adjusted according to target hearing settings, settings of one or more user segments, or the like. In some cases, the speech rate adjustment may take into account the produced speech rate of each user (e.g., referring to the rate at which the user produces speech). For example, the produced speech of a user may be analyzed to customize the speech rate to match the produced speech rate of the user. In some exemplary embodiments, the produced speech rate may be quantified using, for example, a number of produced phonemes in a second, a number of produced words in a minute, or the like.

In some exemplary embodiments, the captured audio channels may be processed in any other way, such as by performing any other adjustment of acoustic parameters or other acoustic aspects. In some exemplary embodiments, the captured audio channels may be processed based on any other parameter, including settings of a user segment, individual hearing settings, or the like.

In some exemplary embodiments, the processing of the captured audio channels may be carried out in real-time, such as during a live streaming, or in an offline manner, such as for a preloaded movie. In some exemplary embodiments, real time processing may be limited to low time lags, latency thresholds, or the like, such as in order to prevent synchronization issues with future media portions, lip-sync issues, or the like, while offline processing may not necessarily have any time lag limitations. For example, a preloaded movie may be processed to match hearing settings of a user segment during a processing phase with unlimited time boundaries, e.g., a processing phase of an hour, an entire night, a week, or the like, after which a processed version of the movie, with an adjusted soundtrack, may be made available to users (e.g., via a VOD platform). According to this example, the processing phase of media may not correspond to the consumption of the media. In some cases, offline processing may have some time-lag limitations, such as in case of visual media that needs to be synchronized with the audio, such as to prevent lip sync issues. In such cases, a maximal lag of audio may be defined as an offline threshold (potentially ranging between negative and positive thresholds). In other cases, such as in case of non-visual media (e.g., a podcast), offline processing may not have time-lag limitations. In some cases, offline processing may utilize processing operations that are more computationally intensive than real-time processing, such as due to the unlimited time boundaries or large time boundaries of offline processing.

In some exemplary embodiments, the processing of the captured audio channels may be artificial intelligence-based, machine-learning-based, digital audio processed, heuristics-based, may deploy audio processes such as a Deep-Audio-Processing (DAP), multiple regression models, or the like. In some exemplary embodiments, the processing of the captured audio channels may be carried out by a dedicated processing device (e.g., Processing Box 820 of FIG. 8, a cloud engine, a server, or the like), by edge devices such as end devices or user devices (e.g., User Devices 851, 852, and 853 of FIG. 8), a combination thereof, or the like.

In some exemplary embodiments, after processing the captured audio channels according to one or more population segments or hearing settings during a processing stage, one or more audio outputs may be generated. For example, each generated audio output signal may correspond to a different user segment, a different hearing setting, or the like. In some exemplary embodiments, the audio outputs may be provided from a dedicated processing device to registered end devices of end users, e.g., based on their classification or hearing settings. In some exemplary embodiments, the audio outputs may be provided to end devices such as smartphones, smart televisions, hearing aids, hearables, laptops, Personal Computers (PCs), cochlear implants, Bluetooth (BT)-based devices such as but not limited to BT headsets, Auracast-based devices such as hearing aids, cochlear implants, or headsets, any other hearing assistive device, or the like.

In other cases, audio outputs may not be provided to end devices. For example, audio outputs may be emitted directly by a third party or public device that does not belong a user such as a public television, a public projector, speakers of a cinema, or the like (e.g., in case the audience belongs to a same population segment). As another example, the processing of the captured audio channels may be performed locally at each end device, and the audio outputs may be produced locally and provided to the respective user. For example, audio channels may be captured and processed at least in part by a Software Development Kit (SDK) executed over a respective user device.

As an example, a processing device, e.g., Processing Box 820 of FIG. 8A, may be used to capture an audio signal in a cinema, and provide different variations thereof to different end users in the audience. In some exemplary embodiments, the processing device may comprise one or more servers, computing clouds, local computing devices, edge devices, a combination thereof, or the like. For example, the processing device may create, on the fly, customized audio signals for different hearing capabilities, user segments, or the like. As another example, the processing device may distribute the captured audio to edge devices, enabling the edge devices to process the audio according to the user segment of their owner. In some exemplary embodiments, the processing device may be connected directly to the audio source, may be connected indirectly to the audio source, may record emitted audio from the audio source, or the like. In some cases, the processing device may process the captured audio according to different user segments, and stream different audio signals to different end devices of users. In other cases, the processing device may stream all the output audio signals to all end devices of users, and end devices may locally select which output audio signal to utilize for generating sound for the respective users.

In some exemplary embodiments, the audio outputs may be provided to end devices via an Application Programming Interface (API) of a variety of software applications (e.g., third-party applications or interfaces) such as web accessibility toolbars, media players, and video-conference applications. In some exemplary embodiments, the audio outputs may be generated as an API, and a variety of software applications may access the API to obtain an output audio stream. In some exemplary embodiments, the audio outputs may be streamed directly to a dedicated software application of registered end devices, such as via a communication medium such as WIFI.

For example, a first user belonging to a first population segment may be registered to the processing device, and a second user belonging to a second population segment may be registered to the processing device. According to this example, the first and second users may be registered to obtain different audio signals from one another, both of which representing the audio in the cinema. For example, the first user may obtain an audio stream with a target speech rate of a first number of Phonemes Per Second (PPS) units or any other type of units such as Words per Minutes (WPM), and the second user may obtain an audio stream with a target speech rate of a second number of PPS units and an adjusted vocals-to-non-vocals ratio. As another example, the processing device may provide young adult users with a first audio signal, elder adults with a second audio signal, people suffering from ADD with a third audio signal, and the like. In some cases, each population segment may receive a variation of the original audio signal that is suitable for their respective hearing capabilities, thus making the original audio signal accessible to all population segments.

One technical effect of utilizing the disclosed subject matter is the generation and delivery of processed audio signals to a plurality of population segments at varying age groups, varying hearing needs such as people with hearing loss, varying attention disorders such as ADD, varying cognitive states, or the like. The processed audio signals may be generated and delivered according to the hearing capabilities and requirements that are associated to each population segment. By providing each user with a processed audio signal that matches their needs, the disclosed subject matter provides each user with an enhanced listening experience with improved intelligibility, clarity, audibility, or the like. In some cases, each population segment may receive a variation of the original audio signal that is suitable for their respective hearing capabilities, thus making the original audio signal accessible to all population segments.

For example, by providing a user with an audio signal with a matching speech rate that can be easily understood by the user, the accessibility and audibility of the audio signal are enhanced, allowing the user to engage in audio-related activities, such as attending cinemas, without experiencing difficulties due to impaired hearing. As another example, an end user belonging to a predetermined population segment may obtain an audio signal with balanced audio components according to the hearing needs of the population segment. As another example, end users may obtain audio signals with a preferred musical instrument being louder than others, with an adjusted loudness dynamic range, an adjusted noise attenuation, or the like.

Another technical effect of utilizing the disclosed subject matter is the generation and delivery of processed audio signals in real time. In some cases, several subprocesses may be utilized in parallel, such as in order to maintain real-time rates. For example, during a real time scenario, the audio customization and processing may be performed within a time threshold of ~0.3 second or less, thereby facilitating real time audio streaming and enabling different user segments to engage in audio-related activities.

Yet another technical effect of utilizing the disclosed subject matter is enabling users to customize their listening experience using enhanced acoustic parameters, such as a vocals-to-non-vocals ratio, a speech rate, weighted acoustic components that match user preferences (e.g., a preferred musical instrument being louder than others), a loudness dynamic range, or the like. It is noted that conventional hearing aids may not provide these customization options.

Yet another technical effect of utilizing the disclosed subject matter is enabling to process and rebalance captured audio channels dynamically, in real-time, or the like, such as based on a content of the captured audio. For example, captured audio channels may be automatically and dynamically adjusted in accordance with the auditory scene, its audio components, or the like.

Yet another technical effect of utilizing the disclosed subject matter is enabling users to hear sounds from remote sources, such as from a soundtrack of a cinema, with enhanced precision and audibility. The disclosed subject matter may provide for one or more technical improvements over any pre-existing technique and any technique that has previously become routine or conventional in the art. Additional technical problem, solution and effects may be apparent to a person of ordinary skill in the art in view of the present disclosure.

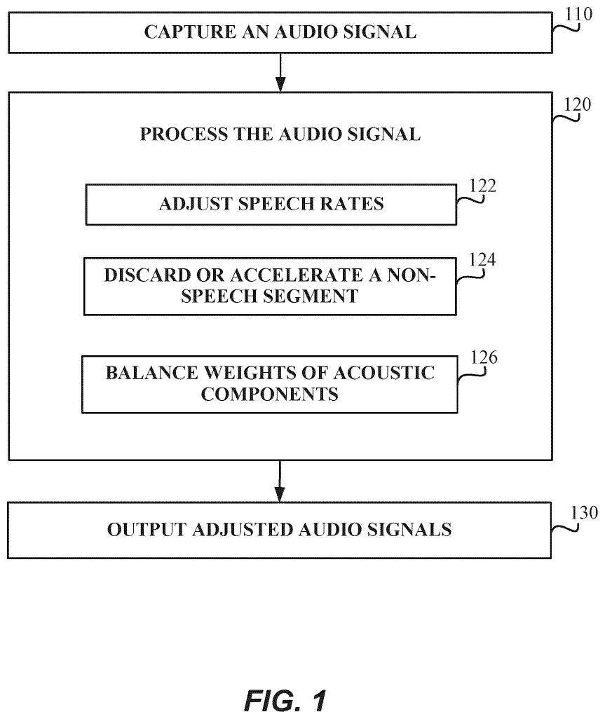

Referring now to FIG. 1 showing an exemplary flowchart diagram, in accordance with some exemplary embodiments of the disclosed subject matter.

On Step 110, an audio signal may be captured from an audio source, e.g., within an environment of a user, externally to the environment of the user, or the like. In some exemplary embodiments, the user may use an end device to consume audio in the environment, such as via an audio output, speakers, communication to earbuds, or the like. For example, the end device may be used to provide a processed version of audio that is emitted or produced by the audio source, to the user. As another example, a processed version of the audio may be provided to the user via a public device, system, or the like, such as a public television. In some cases, the audio signal may be processed during a different timeframe than the consumption of the processed version of the audio signal by the user, at a different environment, or the like. In some cases, the audio signal may be processed and consumed by the user within a same timeframe and environment.

In some exemplary embodiments, the audio signal may be captured in a digital format, in an analogous format, or the like. In some exemplary embodiments, the audio signal may be captured by receiving the audio signal from a console or a mixer associated with the audio source, e.g., via wireless or wired connection. In some exemplary embodiments, the audio signal may be captured by receiving the audio signal directly from the audio source or indirectly, e.g., via a separate device. In some exemplary embodiments, the audio signal may be captured by recording a sound produced by the audio source in the environment, e.g., using microphones. For example, the audio source may comprise an audio source of a cinema, a theater, a television, a second person participating in a conversation with the user, or the like, and the audio signal may be captured therefrom. In some cases, the audio source may comprise a memory storage or repository, and the audio signal may be captured by retrieving the audio signal therefrom.

In some exemplary embodiments, the audio signal may be received as a plurality of separated acoustic components in a respective plurality of audio channels, as a non-separated mixture of a plurality of acoustic components in one or more audio channels, as a limited set of separated acoustic components, or the like. In some exemplary embodiments, the captured audio signal may be represented in the time domain, frequency domain, or any other representation.

On Step 120, the audio signal may be processed. In some exemplary embodiments, the audio signal may be processed based on a plurality of population segments, based on a single population segment, or the like. For example, the audio signal may be processed for users within the vicinity of the audio source (e.g., a determined distance therefrom) that are registered to the processing service, that show interest in obtained a processed version of the audio signal, or the like. As another example, the audio signal may be captured and processed separately at each user device, for the population segment of the respective user. As another example, the audio signal may be captured and processed separately at each user device, for the individual hearing settings and preferences of the respective user.

In some exemplary embodiments, the audio signal may be processed based on a population segment that comprises the user. In some exemplary embodiments, the user may be classified to a respective population segment based on demographic information, such as an age range of the user, a type of hearing impairment, a gender, a cognitive state, a type of attention disorder, or the like. In some exemplary embodiments, the demographic information may be determined based on self-reported data. For example, the user may report their demographic information directly, via a user interface of a dedicated software application presented on the end device. In some exemplary embodiments, the demographic information may be determined indirectly, such as based on global settings of the end device, historic data in the end device, user profiles obtained from a third party, monitored activity of the end device, communications with hearing aid devices of the user, any other data from the end device, or the like. For example, a local software agent may be executed over the end device, collect data therefrom, and create a user profile based on the data, the user profile associated to the population segment.

In some exemplary embodiments, different population segments may correspond to different hearing capabilities, hearing requirements, hearing preferences, or the like. For example, different population segments may correspond to one or more ranges of speech rates that can be understood by each population segment, one or more preferred ratios between different components of the audio signal, or the like. For example, a first population segment may correspond to first dynamic loudness range that matches hearing capabilities of the first population segment, and a second population segment may correspond to second, different, dynamic loudness range, that matches hearing capabilities of the second population segment.

In some exemplary embodiments, the audio signal may be processed to match hearing configurations of one or more population segments, e.g., the population segment of the user. In some cases, the environment of the user may comprise a plurality of people, including at least first and second users having first and second end devices for providing audio output to the first and second users, respectively. For example, the first and second users may be classified to first and second population segments based on their demographic information. According to this example, the audio signal may be processed to obtain, or generate, a first adjusted audio signal that matches hearing capabilities of the first population segment, and the second adjusted audio signal that matches hearing capabilities of a second population segment.

In some exemplary embodiments, in case the audio signal is not a-priori separated into a plurality of acoustic components, the audio signal may be processed by separating the audio signal into a plurality of acoustic components. For example, the audio signal may be split into a plurality of audio channels, each one representing an acoustic component such as a speech component, a music component, and a sound effect component. In some exemplary embodiments, in case the audio signal is a-priori separated into a plurality of acoustic components, e.g., in case a console or a mixer provide separate channels for respective acoustic components, the audio signal may not be processed to be further separated into acoustic components. In some exemplary embodiments, in case the audio signal is a-priori separated into a limited set of acoustic components such as only to speech and non-speech channels, e.g., by a separator component attached to the audio source, the limited set of acoustic components may be processed to further separate the non-speech channel to sub-channels, or, alternatively, the limited set of acoustic components may utilized for Sub-Steps 122-126 as is, without further processing.

In some exemplary embodiments, the audio signal may be processed by a processing unit with or without storing the audio signal at a tangible memory of the processing unit. For example, a media file such as a movie may be locally stored in the processing unit, such as within non-volatile digital memory components such as Solid State Drive (SSD) or Hard Disk Drive (HDD), and processed from there. As another example, a media file may be streamed to the processing unit and processed without being stored in tangible storage. For example, this may involve processing directly from cache memory, processing from the Random-Access Memory (RAM), employing codec processing, or the like. For example, when streaming a media file to a processing unit without storing it in tangible storage, the processing unit may utilize a codec to decode the compressed media data in real-time for further processing.

In some exemplary embodiments, the audio signal may be processed by classifying content of the audio signal to an auditory scene. For example, the content of the audio signal may be classified to an auditory scene such as a conversation, a lecture, a defined movie scene, music, a live performance, aircraft sounds, construction sounds, nature sounds, speech sounds, train sounds, vehicle sounds, or the like.

In some exemplary embodiments, the audio signal may be processed according to Sub-Steps 122-126. In some exemplary embodiments, Sub-Steps 122-126 may or may not operate differently for offline and real-time scenarios, e.g., using more computationally intensive operations for offline scenarios. In some exemplary embodiments, the audio signal may be processed according to settings or configurations of one or more population segments. For example, in case a configuration of the population segment defines a preferred speech rate, speech rate constraints, speech rate limits, or the like, for a determined auditory scene of the audio signal, Sub-Step 122 may be implemented accordingly. As another example, in case a configuration of the population segment defines a limit on a time-lag for a determined auditory scene, Sub-Step 124 may be implemented according to the limit. As another example, in case a configuration of the population segment defines a preferred balance of acoustic components, constraints thereof, or the like, for a determined auditory scene, Sub-Step 126 may be implemented according to the determined balance. It is noted that each sub-step may be performed separately for each population segment, or may calculate simultaneously values for more than one population segment.

On Sub-Step 122, the audio signal may be processed according to a target speech rate for the population segment.

In some exemplary embodiments, a target speech rate for the population segment may be obtained, e.g., from locally stored configurations of different population segments, from a third-party source, or the like. In some exemplary embodiments, the target speech rate may constitute a rate of speech that is deemed suitable to estimated hearing capabilities of members of the population segment, such as the user. In some exemplary embodiments, the target speech rate may be defined with respect to an auditory scene. For example, a first speech rate may be deemed suitable to members of the population segment for a first auditory scene, while a second speech rate may be deemed suitable to members of the population segment for a second, different, auditory scene.

In some exemplary embodiments, the audio signal may be processed by adjusting the audio signal according to the target speech rate of the population segment, limits thereto, constraints thereof, based on the auditory scene, or the like. For example, the target speech rate may comprise a lower speech rate than an original speech rate of the audio signal, and the audio signal may be adjusted to match the lower speech rate. In other cases, the target speech rate may comprise a higher speech rate than the original speech rate.

In some exemplary embodiments, the speech rate may be adjusted on a speech component of the audio signal, such as without processing other components of the audio signal. For example, after adjusting the speech rate of the speech component, the adjusted audio signal may match a target speech rate that is preferred, or audible, to the population segment. In other cases, the speech rate of the speech component may be adjusted for any other number of population segments having any other speech rate requirements. For example, the speech rate may be adjusted according to a second speech rate that is deemed suitable to estimated hearing capabilities of members of a second population segment. According to this example, a second adjusted audio signal that matches the hearing capabilities of the second population segment may be generated and provided to members of the second population segment, e.g., to a second end device of a second user.

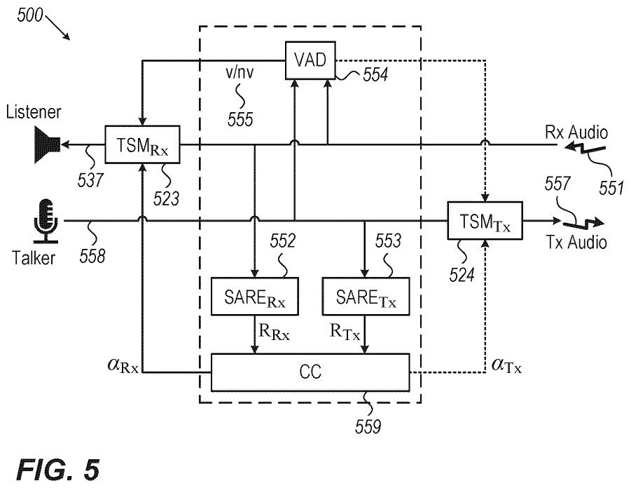

In some cases, a speech rate may be adjusted with a relative factor, such as in order to accommodate an accumulated time-lag (e.g., according to FIG. 5).

On Sub-Step 124, the audio signal may be processed by reducing a latency, or time-lag, which may result from lowering the speech rates of the audio signal, of previously captured audio signals, or the like. In some exemplary embodiments, the latency may be reduced by accelerating a pace of a non-speech segment of the audio signal, dropping or discarding a non-speech segment of the audio signal, or the like. In some cases, latency may be reduced according to configurations of the population segment, according to configurations that relate to the auditory scene, or the like. In real-time scenarios, the time axis may progress exclusively forward, whereas offline scenarios may allow for editing of past audio portions as well. In some exemplary embodiments, in case of offline processing (e.g., for a preloaded video), the latency may be reduced by accelerating a pace of a non-speech segment before and/or after the accelerated speech segment. In some exemplary embodiments, in case of real-time processing (e.g., for a livestream broadcast), the latency may be reduced by accelerating a pace of a non-speech segment only after the accelerated speech component, considering the deterministic nature of the time axis in real-time processing.

On Sub-Step 126, the audio signal may be processed by balancing weights of the plurality of acoustic components according to preferences of different population segment, e.g., based on the respective auditory scene. In some exemplary embodiments, different balances of the acoustic components may represent different vocals-to-non-vocals ratios, dynamic loudness ranges, levels of attenuation of background noise, or the like.

In some exemplary embodiments, acoustic weights of the plurality of acoustic components may be applied according to preferences of the population segment. In some cases, the preferences of the population segment may or may not be defined with respect to an estimated auditory scene. For example, the population segment may correspond to utilizing a first set of weights in case of a first auditory scene, and utilizing a second set of weights in case of a second auditory scene. In some cases, after balancing the weights of the acoustic components, the adjusted audio signal may match a balance that is preferred, or audible, to the population segment.

In other cases, the audio signal may be processed in any other way.

On Step 130, one or more generated output signals may be provided to respective end devices, e.g., according to their population segment. In some cases, the adjusted audio signal may be provided to end devices that are classified as belonging to the population segment, e.g., the end device of the user. For example, the end device may serve the adjusted audio signal to the user via a headphone connection, via speakers, or the like.

In some cases, the generated output signals may not be provided to respective end devices, such as in case the processing of Step 120 is performed locally at each user device, in case that the generated output signals are provided to a publicly shared audio emitting device, or the like.

In some cases, different adjusted audio signals may be generated separately and provided to different population segments. For example, a first adjusted audio signal may be provided to all end devices (within a vicinity of the audio source) that belong to a first population segment, and a second adjusted audio signal may be provided to all end devices that belong to a second population segment. In some cases, end devices may have local setting that may enable to further customize the adjusted audio signal.

In some exemplary embodiments, the generated output signals may be provided to respective end devices by sending the output signals to dedicated software applications of the end devices, by making the output signals accessible via an API that can be reached by third-party software applications of the end devices, by making the output signals accessible via web-based applications, by making the output signals accessible via a desktop application, by making the output signals accessible via a mobile application, by making the output signals accessible via a website, by obtaining the output signals from a memory storage or library, or the like. For example, the adjusted audio signal may be obtained via API calls made by third-party software applications of the end device.

Referring now to FIG. 2 showing an exemplary schematic block diagram, in accordance with some exemplary embodiments of the disclosed subject matter.

In some exemplary embodiments, Block Diagram 200 may depict blocks, each of which represents a component, stage, subprocess, or subsystem of the disclosed subject matter, and interconnections between the blocks may illustrate how these components interact or are related in terms of functionality or information flow. In some exemplary embodiments, one or more of the blocks may be implemented in parallel, in overlapping timeframes, or the like, such as in order to maintain real-time rates. For example, Audio Source Separation (ASS) Module 210 and Audio Content Classifier (ACC) Module 220 may be implemented in parallel, at partially overlapping times, or the like.

In some exemplary embodiments, Block Diagram 200 may depict an audio processing framework that is configured to process one or more captured audio channels according to hearing capabilities and requirements of different users, population segments, or the like. For example, Block Diagram 200 may represent a general architecture of a Deep-Audio-Processing (DAP) framework. In some exemplary embodiments, Block Diagram 200 may be implemented by a central processing unit, locally at distributed user devices, a combination thereof, or the like.

As depicted in FIG. 2, a flow of Block Diagram 200 starts with Input Audio 201 being provided to Audio Source Separation (ASS) Module 210 and to Audio Content Classifier (ACC) Module 220. In some exemplary embodiments, the environment associated with Input Audio 201 may comprise an environment that is acoustically challenging or aurally challenging to one or more users. For example, Input Audio 201 may correspond to an audio signal produced in a cinema, in a theater, in a noisy restaurant, or the like. As another example, Input Audio 201 may correspond to a soundtrack of a video in a VOD platform such as Netflix™. In some exemplary embodiments, Input Audio 201 may be obtained in a digital format, in an analogue format, or the like. For example, Input Audio 201 may be converted to a digital format from an analogue format.

In some exemplary embodiments, Input Audio 201 may be obtained from one or more sound sources of the cinema (e.g., from speakers, a console, a mixer), or the like, directly or indirectly. For example, Input Audio 201 may be obtained from an audio source directly via a cable, a wireless connection, or the like, indirectly via an intermediate device or component, or the like. In some cases, Input Audio 201 may comprise one or more audio channels that are recorded in the noisy environment. In one scenario, Block Diagram 200 may continuously obtain one or more audio channels from the audio source, such as Input Audio 201, and process them according to FIG. 2.

In some exemplary embodiments, Input Audio 201 may comprise a product or mixture of a plurality of acoustic components, such as speech segments, musical instrument segments, sound effect segments, or the like. In some exemplary embodiments, in case Input Audio 201 is provided as a non-separated mixture of different acoustic components, e.g., as a single monophonic (mono) channel, a single stereo channel, a plurality of mono channels, a plurality of stereo channels, or the like, such as in case Input Audio 201 is recorded, ASS Module 210 may be applied thereto for performing source separation. For example, ASS Module 210 may be configured to separate a mixture of sounds into individual acoustic components.

In some exemplary embodiments, Input Audio 201 may comprise a product or mixture of a limited set of channels, such as speech and non-speech channels. In such cases, ASS Module 210 may be applied to Input Audio 201 for performing additional source separation. For example, Input Audio 201 may be processed by a third-party component that is connected to the audio source, e.g., an audio separator, and then processed by ASS Module 210 for separating the non-speech channel into additional acoustic components. As another example, Input Audio 201 may be provided via a console or a mixer of the audio source in two or more channels (e.g., speech and non-speech), which may be directly provided to ASS Module 210 for separating the channels into additional acoustic components.

In some exemplary embodiments, ASS Module 210 may be omitted, or not used, in one or more cases. For example, in case Input Audio 201 is provided as a plurality of separated acoustic components, such as in case Input Audio 201 is obtained directly from a source of a target sound (e.g., interfacing a console or a mixer thereof), ASS Module 210 may not necessarily be applied thereon. For example, in case Input Audio 201 is a-priori divided into different sound components, the application of ASS Module 210 may be redundant. As another example, in case Input Audio 201 is a-priori divided into a limited set of channels, such as speech and non-speech channels, ASS Module 210 may be omitted, and the processing of ACC Module 220, Enhancement & Equalization Logic (EEL) Module 230, and Audio Enhancement & Equalization (AEE) Module 240 may be performed with respect to the limited set of channels, e.g., by replacing Music 212 and Sound Effects 213 with the non-speech channel. In case Input Audio 201 is a-priori divided into separate audio channels, e.g., which may occur when interfacing with a console, a mixer, or the like, ASS Module 210 may be omitted, may not be applied to Input Audio 201, or the like. For example, in such cases, the separate audio channels may be directly provided to EEL Module 230 and AEE Module 240.

In some exemplary embodiments, in case ASS Module 210 is utilized, ASS Module 210 may perform source separation using any source separation technique. In some exemplary embodiments, ASS Module 210 may obtain Input Audio 201 and process it to separate a mixture of sounds into individual acoustic components, sound types, guitar sounds, bass sounds, drum sounds, singer sounds, or the like. In some exemplary embodiments, ASS Module 210 may be configured to disassemble Input Audio 201 into two or more acoustic components, audio channels, acoustic components, or the like. For example, ASS Module 210 may be configured to disassemble Input Audio 201 into a first audio channel representing speech segments in Input Audio 201 (e.g., denoted ‘Speech 211’), a second audio channel representing music segments in Input Audio 201 (e.g., denoted ‘Music 212’), a third audio channel representing sound effect segments in Input Audio 201 (e.g., denoted ‘Sound Effects 213’), or the like. In other cases, ASS Module 210 may disassemble Input Audio 201 into any other types of audio channels, any other number of audio channels, or the like.

In some exemplary embodiments, during one or more simultaneous or overlapping timeframes to the processing of ASS Module 210, or independently of the processing of ASS Module 210, ACC Module 220 may be configured to obtain Input Audio 201. In some exemplary embodiments, in case Input Audio 201 comprises a plurality of separate audio channels (e.g., when Input Audio is obtained from the source of the target sound), ACC Module 220 may be configured to perform a pre-processing stage of combining the different channels into a single unified audio signal for analysis. For example, in case Input Audio 201 comprises the a-priori separated channels Speech 211, Music 212, and Sound Effects 213, ACC Module 220 may combine the different channels into a single audio signal. In other cases, when Input Audio 201 comprises a single audio channel, ACC Module 220 may process Input Audio 201 without the pre-processing stage.

In some exemplary embodiments, ACC Module 220 may be configured to process the audio channel of Input Audio 201 by performing a classification of an auditory scene associated with Input Audio 201. In some exemplary embodiments, ACC Module 220 may classify the content of Input Audio 201 into one or more different auditory scene classes, which may encompass scenarios such as a conversation, a lecture, an action scene or any other type of scene from a movie, music, a live performance, or the like. For example, a plurality of auditory scenes may be defined, and the ACC Module 220 may be configured to classify, for each obtained audio signal, a respective auditory scene.

In some exemplary embodiments, ACC Module 220 may predict, for each determined class of auditory scenes, a likelihood that Input Audio 201 belongs to that class. For example, ACC Module 220 may utilize one or more predictors, classifiers, semantic analyzers, audio to text converters, machine learning modules, deep learning modules, or the like, for the class prediction. In some exemplary embodiments, ACC Module 220 may determine and output for each class of auditory scenes, a score indicating the likelihood that the content of Input Audio 201 matches the specific class. For example, a supervised deep learning module may be trained against a corpus of different labeled audio signals, to provide a score for each class.

In some exemplary embodiments, the class prediction of ACC Module 220 may enable to process and rebalance Input Audio 201 dynamically, in real-time, in near-real-time, in an offline mode, or the like, such as based on a content of the captured audio. For example, Input Audio 201 may be automatically and dynamically adjusted in accordance with the auditory scene, its acoustic components, or the like, at Enhancement & Equalization Logic (EEL) Module 230 and/or Audio Enhancement & Equalization (AEE) Module 240, based on the classified auditory scene. In some cases, ACC Module 220 may provide the multi-class scores to EEL Module 230. In other cases, ACC Module 220 may provide only an indication of the highest scoring class to EEL Module 230.

In one scenario, in a real time scenario (e.g., real time streaming of a game), the class prediction of ACC Module 220 may be performed in real time or near-real-time, e.g., under a respective latency threshold. In this scenario, the processing of EEL Module 230 and/or AEE Module 240 may be performed under the same latency threshold, under a greater threshold, under a lesser threshold, or the like. In another scenario, the class prediction of ACC Module 220 may be performed in an offline mode. In this scenario, for visual media such as a movie, the processing of ACC Module 220, EEL Module 230 and/or AEE Module 240 may be performed under one or more offline latency thresholds, while for audio-only media, the processing may be performed without any latency threshold.

In some exemplary embodiments, subsequently to the processing of ASS Module 210 and ACC Module 220, or at partially overlapping times, EEL Module 230 may be configured to process outputs from ASS Module 210 and ACC Module 220. In some cases, such as when ASS Module 210 is omitted, EEL Module 230 may be configured to process the output from ACC Module 220, without relying or processing an output from ASS Module 210.

In some exemplary embodiments, EEL Module 230 may be configured to obtain one or more class scores from ACC Module 220, indicating the probabilities that Input Audio 201 matches each class of auditory scenes. In some exemplary embodiments, in case ASS Module 210 is deployed, EEL Module 230 may be configured to obtain the different acoustic components outputted by ASS Module 210, e.g., Speech 211, Music 212, Sound Effects 213, or the like. In some exemplary embodiments, in case ASS Module 210 is not applied, EEL Module 230 may be configured to obtain the different acoustic components directly from the source of the target sound, e.g., the mixer, console, or the like.

In some exemplary embodiments, EEL Module 230 may be configured to obtain an indication of a target user segment, acoustic constraints of the user segment, a hearing capability or requirement of a target user, or the like (e.g., denoted ‘mode’). For example, the acoustic constraints of a population segment may define musical instruments that are preferred over other musical instruments, a ratio between singer to musical instruments, a preferred loudness dynamic range, a preferred background noise attenuation rate, a preferred speech rate, or the like.

In some exemplary embodiments, EEL Module 230 may be configured to determine an adjustment to one or more acoustic parameters of the different acoustic components of Input Audio 201, based on the target user segment (e.g., its acoustic constraints) and the class scores from ACC Module 220. For example, EEL Module 230 may determine to adjust the one or more acoustic parameters by determining to apply one or more weights of the different acoustic components (e.g., according to a desired balance), by determining to adjust a speech rate to a defined rate, or the like.

In some exemplary embodiments, EEL Module 230 may be configured to determine a plurality of weights for the different acoustic components, respectively, based on the class scores from ACC Module 220, the user segment, or the like. For example, in case the user segment has constraints that define that, for crime scenes, the vocals-to-non-vocals ratio must be at least 80% due to a hearing deficiency that characterized the user segment, and in case ACC Module 220 classifies Input Audio 201 as a crime scene, EEL Module 230 may determine weights that ensure a vocals-to-non-vocals ratio of at least 80%.

In some exemplary embodiments, EEL Module 230 may be configured to determine an adjusted speech rate for a speech acoustic component, e.g., if ASS Module 210 determined that a speech acoustic component exists, if ASS Module 210 outputs a speech acoustic component, or the like. In some exemplary embodiments, the adjusted speech rate may be determined based on the class scores from ACC Module 220, based on the user segment, based on the scenario being real-time or offline, or the like. For example, in case the user segment has constraints that define that, for songs, the speech rate must be slowed down by to at least a certain rate (e.g., in PPS units), to a preferable PPS rate, by a certain percentage such as 20%, or the like, and in case ACC Module 220 classifies Input Audio 201 as a vocal song, EEL Module 230 may determine to decrease the speech rate of Input Audio 201 accordingly, potentially under one or more time-lag constraints. For example, when a hard-of-hearing person is speaking with a second person, reducing the speech rate of the second person may allow the hard-of-hearing person to better understand the second person.

In some exemplary embodiments, EEL Module 230 may comprise one or more Adaptive Speech Rate (ASR) modules, such as one or more components of the ASR Module of FIG. 5. In some exemplary embodiments, EEL Module 230 may deploy an ASR Module, or portion thereof, in order to estimate a speech rate of Input Audio 201, and determine how to adjust Input Audio 201 based on the estimated speech rate. In some cases, EEL Module 230 may utilize the ASR Module in order to estimate a speech rate of the user's speech, such as in order to determine how to adjust Input Audio 201 to match the user's own speech.

In some exemplary embodiments, EEL Module 230 may determine one or more adjustments to Input Audio 201, or to one or more future input audio channels, that are meant to minimize any adverse effects of applying the ASR module on Input Audio 201 or portion thereof. For example, in a cinema scenario, adverse effects of applying the ASR module to reduce a speech rate may comprise lip-sync issues between the produced audio, which may have a reduced speech rate, and corresponding images of the presented movie broadcast, which may not correspond to the reduced speech rate. As another example, such as in a conversation scenario, adverse effects of applying the ASR module to reduce a speech rate may comprise creating a latency in the consumption of Input Audio 201 by the user, which may reduce the quality of the conversation.

In some exemplary embodiments, in order to mitigate the adverse effects, EEL Module 230 may determine a maximal time-lag threshold, such as a time lag that does not exceed a threshold of 800 milliseconds (ms), 600 ms, 500 ms, 400 ms, or the like, which may be to enforced over the ASR module, over AEE Module 240, or the like. For example, this may be performed for real-time scenarios, for visual media scenarios, or the like, such as in order to limit the potential delays and lip-sync issues to the threshold.

In some exemplary embodiments, in order to mitigate the adverse effects, EEL Module 230 may determine one or more adjustments to Input Audio 201 or to future input audio channels, that are configured to reduce the aggregated time-lag. For example, EEL Module 230 may determine to identify the non-vocal segments of an obtained audio signal, e.g., as determined by ASS Module 210, and to accelerate their pace, such as in order to synchronize with the original audio timeline, reduce the time lag, or the like. As another example, EEL Module 230 may determine to identify non-vocal segments of an obtained audio signal, e.g., as determined by ASS Module 210, and to remove (also referred to as ‘drop’) these segments, such as in order to synchronize with the original audio timeline, reduce the time lag, or the like. In some exemplary embodiments, in case of offline processing, the non-vocal segments may be adjusted before and after the speech channels with the reduced speech rate, while for real-time scenarios, the non-vocal segments may be adjusted only after the speech channels with the reduced speech rate.

In some exemplary embodiments, in case the aggregated time-lag reaches the maximal time-lag threshold, no additional delay may be allowed to be introduced by the ASR module until a non-voice segment is identified and utilized to reduce the aggregated time-lag, e.g., by dropping or accelerating the non-voice segment.

In some exemplary embodiments, one or more different scale parameters, defining a pace of speech and/or associated audio properties, may be implemented, in view of the aggregated time-lag. For example, a scale parameter may be multiplied by relative factor defined as:

$$( 1 - \frac{T i m e L a g}{L a g Thershold} ) \qquad ( 1 )$$

where TimeLag is the aggregated time-lag and LagThreshold is the maximal time-lag threshold (e.g., the maximal allowed aggregated time-lag for the current situation, depending on whether the scenario is real-time, offline, includes visual media, or the like). Using such a relative factor may allow for longer delays when the aggregated time-lag is minimal and shorter delays when the aggregated time-lag is close to the maximal allowed time-lag, defined by the time-lag threshold. In other embodiments, instead of using continuous relative factor, a non-continuous relative factor may be utilized for different aggregated time-lags. For example, the relative factor, relFactor, may be defined as follows:

$$relFactor = \{ \begin{matrix}1 & TimeLag < 100 ms \\ 0.7 & 100 md \leq TimeLag < 300 ms \\ 0.5 & 300 ms \leq TimeLag \leq LagThrehold\end{matrix} \qquad ( 2 )$$

In some exemplary embodiments, Equation 2 may define different relative factors for different aggregated time-lag segments, causing the delay to be minimized as the aggregated time-lag is increased. In some exemplary embodiments, the determined instructions for reducing the aggregated time-lag are denoted as “EE Instructions” 440.

In some exemplary embodiments, EEL Module 230 may be configured to determine any other adjustments to the acoustic components, instructions to be applied thereto, or the like.

In some exemplary embodiments, EEL Module 230 may be configured to provide its determinations to AEE Module 240. For example, EEL Module 230 may be configured to provide the determined weights for the acoustic components, the determined speech rate, and the determined instructions for reducing the aggregated time-lag, to AEE Module 240, to be implemented thereby. In some exemplary embodiments, in addition to the outputs from EEL Module 230, AEE Module 240 may be configured to obtain the different acoustic components, e.g., as outputted by ASS Module 210, as obtained directly from the source of the target sound, or the like.

In some exemplary embodiments, AEE Module 240 may be configured to process the different acoustic components according to the instructions from EEL Module 230. For example, AEE Module 240 may be configured to process the different acoustic components according to the plurality of weights from EEL Module 230. In some exemplary embodiments, AEE Module 240 may be configured to apply the plurality of weights on the different acoustic components, to thereby obtain a balanced combination of acoustic components that matches a target user segment.

In some exemplary embodiments, AEE Module 240 may be configured to apply the determined speech rate from EEL Module 230 on one or more channels of Input Audio 201, e.g., using one or more ASR modules, components thereof, or the like. For example, AEE Module 240 may deploy an ASR Module or portions thereof in order to modify the speech rate of Input Audio 201 according to the instructed speech rate. In some exemplary embodiments, an ASR Module may be applied on a subset of the plurality of separated channels, such as on a speech acoustic component of Input Audio 201. In some cases, the ASR module may be correspond to one or more components of ASR Module 500 shown in FIG. 5. In some exemplary embodiments, by reducing the speech rate to match a processing capability of a target user segment, Input Audio 201 may become accessible and audible to the target user segment.

In some cases, AEE Module 240 may apply the ASR module as a single-sided ASR module, a dual-sided ASR module, or the like. For example, a single-sided ASR module may be configured to adjust a speech rate of a single side of speech, e.g., Input Audio 201, while a dual-sided ASR module may be configured to adjust a speech rate of both Input Audio 201 and of the produced speech of the user.

In some exemplary embodiments, AEE Module 240 may be configured to implement one or more accelerations of non-speech segments of Input Audio 201, disregard one or more non-speech segments of Input Audio 201, or the like, such as based on the instructions for reducing the aggregated time-lag, based on the time-lag threshold, or the like.

In some exemplary embodiments, AEE Module 240 may be configured to output a combined, or re-assembled, processed Audio Output 247. In some exemplary embodiments, Audio Output 247 may correspond to Input Audio 201, but may differ therefrom in many ways. For example, Audio Output 247 may have a different speech rate from Input Audio 201 that is more suitable to the target user segment, may have a different balance of proportion of each acoustic component, may omit or have one or more accelerated non-speech segments, or the like, e.g., in accordance to instructions from EEL Module 230.

In some exemplary embodiments, AEE Module 240 may provide Audio Output 247 to one or more end users, such as via their registered end devices, via an API that is accessible to the end device, via speakers of an end device implementing Block Diagram 200, or the like. In some exemplary embodiments, Block Diagram 200 or components thereof may be implemented as an API that is accessible to a variety of software applications, third-party applications, web accessibility toolbars, media players, video-conference applications, or the like, enabling end devices such as smartphones, televisions and hearing-aids to consume the API through the applications. In some cases, Block Diagram 200 may be integrated within a computing device, such as by implementing Block Diagram 200 in a dedicated chip embedded within the device, operating Block Diagram 200 through a software application that is executed by the device, or the like. For example, Block Diagram 200 may be implemented by a website, a web-based engine or application, a smart television, a conference software application, a mobile application, or the like. In some cases, each user may consume the obtained audio stream of Audio Output 247 via speakers of such end devices, earphone of the end devices, hearing aids, cochlear implants, or the like.

In some exemplary embodiments, Block Diagram 200 or components thereof may be implemented for each user segment that is registered, to user segments that are in the environment of Input Audio 201, or the like. In some cases, ASS Module 210 and ACC Module 220 may be performed once for all user segments, while EEL Module 230 and AEE Module 240 may perform different calculations for different user segments, may be implemented separately for each user segment, or the like.

In some exemplary embodiments, implementing Block Diagram 200 may enable to process and rebalance the audio content in real-time, such as based on dynamically changing classifications of ACC Module 220 every defined period. For example, the classifications of ACC Module 220 may be used to adjust the obtained audio according to hearing needs of end-users, in view of the real time auditory scene. In some exemplary embodiments, obtained audio channels may be adjusted automatically and dynamically based on the auditory scene depicted therein, the different acoustic components of Input Audio 201, the population segment's hearing needs, acoustic setting of end users, or the like.

In some exemplary embodiments, when implementing Block Diagram 200, an end-user belonging to a target population segment may obtain a listening experience with balanced acoustic components according to the hearing needs of his segment, with a speech rate that matches (potentially under certain constraints such as a time-lag threshold) preferences and/or settings of his population segment, with an acceptable time-lag, or the like. For example, Audio Output 247 may comprise a preferred musical instrument being louder than others, an adjusted loudness dynamic range, an adjusted noise attenuation, an adjusted target speech rate, or the like, matching the acoustic preferences of the user's segment. For example, Audio Output 247 may match one or more predetermined population segments having varying age groups, varying hearing needs, ADD, cognitive decline, or the like.

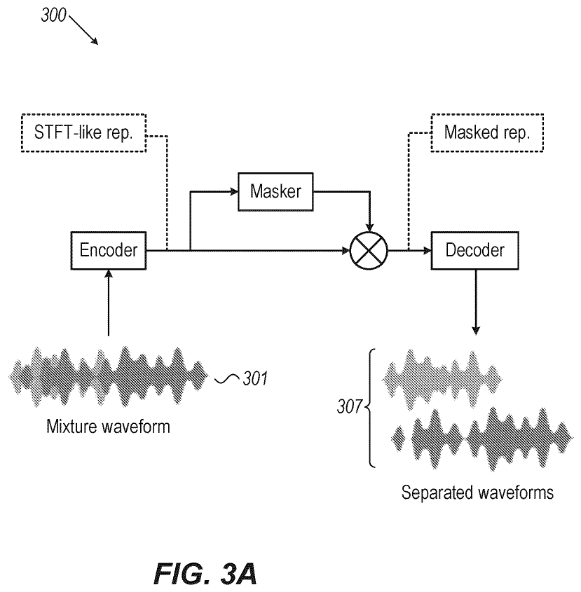

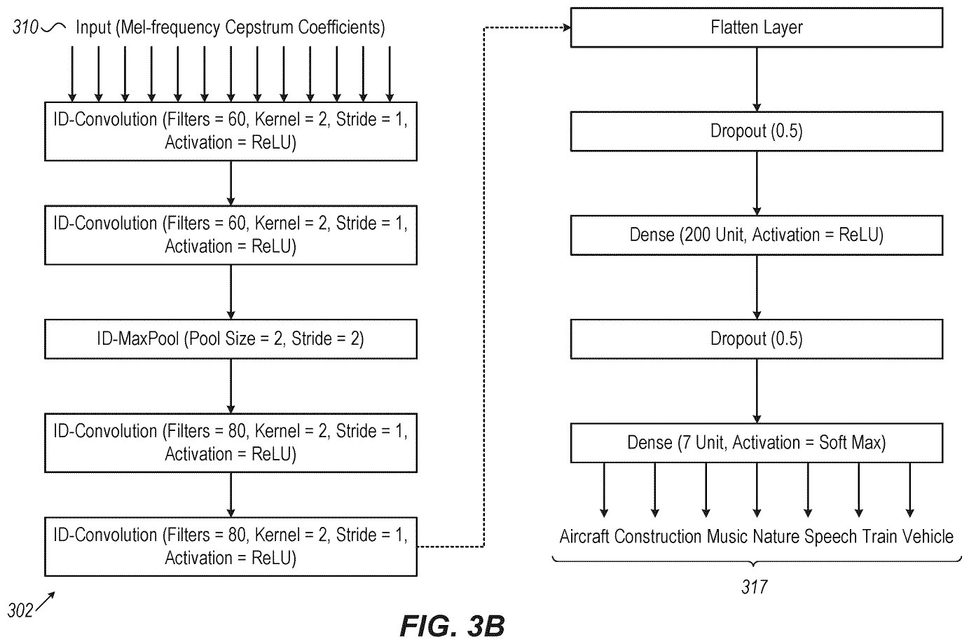

Referring now to FIG. 3A, depicting an exemplary source separation process, in accordance with some exemplary embodiments of the disclosed subject matter.

In some exemplary embodiments, Source Separation 300 may incorporate an implementation of ASS Module 210 (FIG. 2). In some exemplary embodiments, as depicted in FIG. 3A, Source Separation 300 may obtain as input a mixed audio signal, or waveform, that is not separated to different acoustic channels, e.g., Audio Signal 301. In some cases, Audio Signal 301 may correspond to Input Audio 201 (FIG. 2).

In some exemplary embodiments, Source Separation 300 may be configured to apply an audio source separation process to Audio Signal 301. In some exemplary embodiments, Source Separation 300 may separate a mixture of sounds within Audio Signal 301, into individual separated acoustic channels, acoustic components, acoustic waveforms, or the like, e.g., Acoustic Components 307. In some exemplary embodiments, Source Separation 300 may be configured to disassemble Audio Signal 301 into two or more acoustic components. For example, Source Separation 300 may be configured to disassemble Audio Signal 301 into a first audio channel representing speech segments in Audio Signal 301, a second audio channel representing music segments in Audio Signal 301, a third audio channel representing sound effect segments in Audio Signal 301, or the like. In other cases, Source Separation 300 may disassemble Audio Signal 301 into any other types of audio channels, any other number of audio channels, or the like.

In some exemplary embodiments, Source Separation 300 may comprise one or more deep-learning-based modules, heuristic predictors, or the like, which may be configured to perform source separation in real time (e.g., corresponding to a real time threshold), near real time (e.g., corresponding to a near-real time threshold), offline (e.g., corresponding to an offline threshold or not limited to a latency threshold), or the like. In some exemplary embodiments, Source Separation 300 may deploy one or more source separation modules, such as a universal separation network (such as disclosed in Kavalerov, I., Wisdom, S., Erdogan, H., Patton, B., Wilson, K., Le Roux, J., & Hershey, J. R. Universal sound separation. IEEE Workshop on Applications of Signal Processing to Audio and Acoustics (WASPAA) (pp. 175-179). (2019 October). which is hereby incorporated by reference in its entirety without giving rise to disavowment). In other cases, any other source separation technologies that comply with a time processing threshold may be implemented or deployed. For example, a source separation technology may be implemented in case it is capable of complying with a threshold (a real time or near-real time threshold) of 300 ms, 200 ms, 150 ms, or the like. In some exemplary embodiments, by ensuring that Source Separation 300 complies with a time processing threshold, Source Separation 300 may be configured to provide continuous sound source separations in real time, in a low latency, within a relatively short timeframe, or the like.

It is noted that, when referring to operating in real time or near real time, the disclosed subject matter relates to operations that comply with a real time threshold and a near-real time threshold, respectively. For example, the near-real time threshold may allow a greater latency than the real time threshold.

In some cases, Source Separation 300 may be configured to separate Audio Signal 301 into Acoustic Components 307, such as by providing Audio Signal 301 to an encoder, such as in order to convert Audio Signal 301 from the time domain to the frequency domain. For example, the encoder may comprise one or more digital or analog converters such as a Short-Time Fourier Transform (STFT) transformation. In some exemplary embodiments, after encoding Audio Signal 301, one or more maskers may be applied, in order to mask or suppress background sounds and non-related acoustic components for each sound source. For example, for each type of acoustic component, the remaining acoustic components may be suppressed, while signals associated to the acoustic component may be emphasized. In some exemplary embodiments, after generating different signals for each acoustic components, the generated signals may be decoded, such as by converting the signals back from the frequency domain to the time domain, thereby obtaining a plurality of separated Acoustic Components 307.

Referring now to FIG. 3B, depicting an exemplary process of audio content classification, in accordance with some exemplary embodiments of the disclosed subject matter.

In some exemplary embodiments, Content Classification 302 may incorporate an implementation of ACC Module 220 (FIG. 2). In some exemplary embodiments, as depicted in FIG. 3B, Content Classification 302 may obtain as input an audio signal, e.g., Input 310, which may correspond to Input Audio 201 (FIG. 2), and apply thereto one or more audio content classification processes.

In some exemplary embodiments, Content Classification 302 may be configured to classify the content of the audio signal into different auditory scene classes, which may encompass defined scenarios such as a conversation, a lecture, an action scene from a movie, music, a live performance, or the like. For example, a plurality of auditory scenes may be predefined, and Content Classification 302 may be configured to classify, for each obtained audio signal, a respective auditory scene.

In some exemplary embodiments, Content Classification 302 may perform audio content classification using one or more Convolution Neural Networks (CNNs), a Dilated CNN (DCNN), deep learning classifiers, predictors, semantic analyzers, audio-to-text converters, or the like. For example, Content Classification 302 may implement one or more automatic audio event recognition schemes for context-aware audio computing devices, such as using a DCNN, as disclosed in Soni, S., Dey, S., & Manikandan, M. S. Automatic audio event recognition schemes for context-aware audio computing devices. Seventh International Conference on Digital Information Processing and Communications (ICDIPC) (pp. 23-28). (2019 May), which is hereby incorporated by reference in its entirety without giving rise to disavowment).

In some exemplary embodiments, Content Classification 302 may be configured to predict, for each determined class of auditory scenes, a likelihood that the audio signal belongs to that class. For example, Content Classification 302 may operate in a multiclass framework that enables the detection and identification of auditory “events” occurring in the input audio. In some exemplary embodiments, Content Classification 302 may determine and output for each class of auditory scenes, a score indicating the likelihood that the content of audio signal matches the specific class. For example, a supervised deep learning module may be trained against a corpus of different labeled audio signals (e.g., each audio signal labeled with a respective auditory scene), to provide a score for each class.

In some cases, as depicted in FIG. 3B, Content Classification 302 may deploy a feature extraction technique, such as Mel-Frequency Cepstrum (MFC), to compactly represent the spectral envelope of Input 310, e.g., as part of a pre-processing stage of Content Classification 302. For example, Input 310 may be represented by values of MFC coefficients such as Mel-Frequency Cepstral Coefficients (MFCCs), which may capture significant or important characteristics of speech and other types of audio features within Input 310. In some cases, after pre-processing Input 310 to extract its MFC coefficients, the MFC coefficients may be fed to a CNN module, such as a DCNN module with a plurality of convolutional layers. For example, the convolutional layers may comprise one or more one-dimensional (1D) convolutional layers, one or more 1D pooling layers, one or more flatten layers, one or more dropout layers, one or more dense layers, or the like. In some exemplary embodiments, the CNN module may output a plurality of class scores, e.g., Scores 317, indicating the probabilities that Input 310 matches each class of auditory scenes. For example, Scores 317 may determine probabilities that Input 310 matches the auditory scenes of aircraft sounds, construction sounds, music, nature sounds, speech sounds, train sounds, and vehicle sounds.

In some exemplary embodiments, Content Classification 302 may or may not operate in real time, e.g., latency-wise. For example, Content Classification 302 may analyze a streamed audio signal and classifies the first 60 seconds as a “music” auditory scene and the following 5 minutes as a “conversation in background noise” auditory scene, e.g., in offline computations, real time computations, or the like. In some cases, Content Classification 302 may operate in real time, as part of a real-time processing flow of the audio signal, in case this is enabled while complying with a real-time latency threshold. In some cases, Content Classification 302 may not operate in real time, or may operate at an offline mode of operation that is independent from real time processing (e.g., using batch processing), or the like, in case a real-time latency threshold cannot be complied with. For example, in case a latency of Content Classification 302 is relatively high, e.g., above the real-time latency threshold, real time processing may not be performed. In some cases, offline processing may comprise batch processing, periodical processing, or the like, each time utilizing the classification output for the subsequent production of audio output. For example, Content Classification 302 may provide an updated content classification every period of 1 second (or any other period such as 0.5 seconds, 5 seconds, 10 seconds, 20 seconds, 30 seconds, or the like), and such classification may be utilized for the production of subsequent audio output, under the assumption that the auditory scene is relatively consistent. In some cases, a classification of an auditory scene may be utilized for production of subsequent audio output until a different content classification is determined.

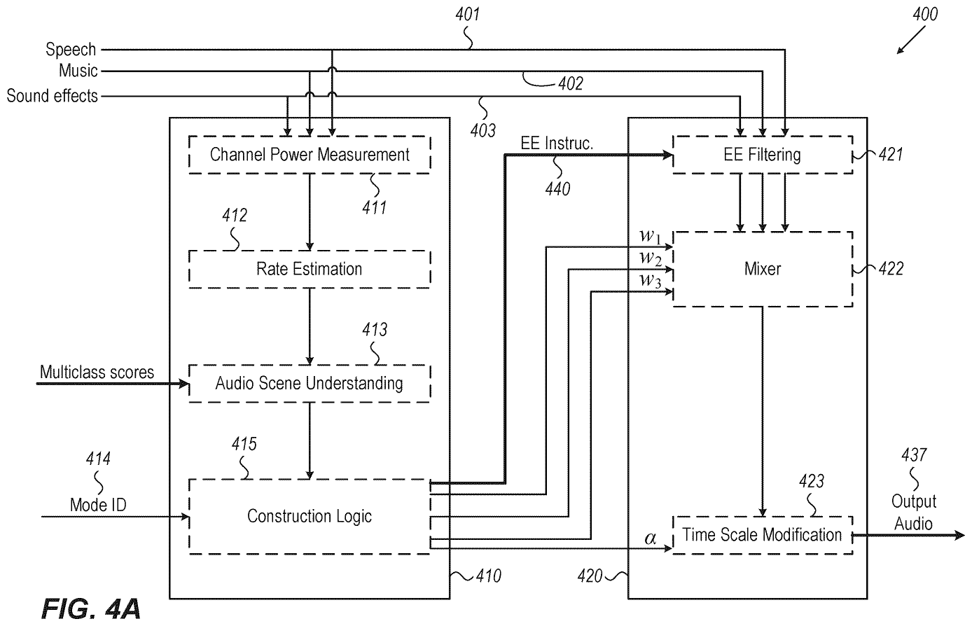

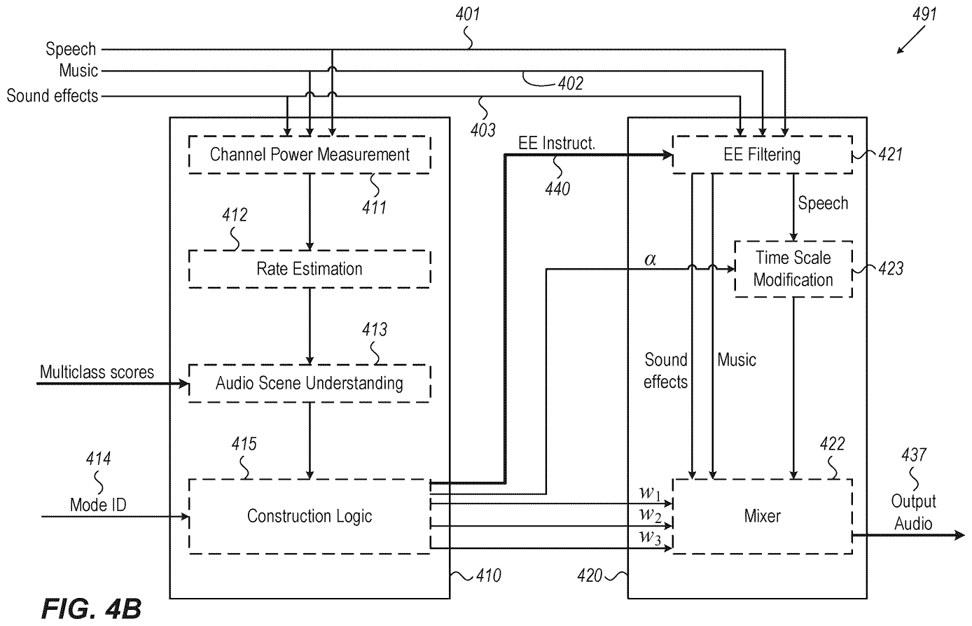

In some exemplary embodiments, after classifying the audio signal to classes, the classification scores may be fed to an enhancement and equalization module, e.g., Enhancement Process 410 of FIG. 4A, e.g., for further processing.

Referring now to FIG. 4A, depicting an exemplary schematic block diagram, in accordance with some exemplary embodiments of the disclosed subject matter.

In some exemplary embodiments, the schematic block diagram may comprise one or more audio enhancement processes, such as Audio Enhancement Processes 400. Audio Enhancement Processes 400 may depict blocks, each of which represents a component, stage, subprocess, step, or subsystem of the disclosed subject matter, and interconnections between the blocks may illustrate how these components interact or are related in terms of functionality or information flow. In some exemplary embodiments, one or more of the blocks may be implemented in parallel, in overlapping timeframes, or the like, in order to maintain real-time rates.

In some exemplary embodiments, Audio Enhancement Processes 400 may comprise processes that correspond to EEL Module 230 and AEE Module 240 of FIG. 2. For example, Audio Enhancement Processes 400 may comprise a first audio enhancement process, e.g., Enhancement Process 410 that may correspond to EEL Module 230 of FIG. 2, and a second audio enhancement process, e.g., Enhancement Process 420 that may correspond to AEE Module 240 of FIG. 2.

In some exemplary embodiments, Enhancement Process 410 may be configured to obtain a plurality of acoustic components, such as separated Acoustic Components 307 that are disassembled on FIG. 3A, separated acoustic components that are provided separately from a sound source, or the like. For example, as part of Stage 411, Enhancement Process 410 may be configured to obtain separate audio channels including Speech Component 401, Music Component 402, and Sound Effects Component 403.

In some exemplary embodiments, Enhancement Process 410 may be configured to measure the power of each audio channel or waveform, e.g., of each channel of Speech Component 401, Music Component 402, and Sound Effects Component 403, a subset thereof, or the like. For example, the power may be measured as part of Stage 411. In some exemplary embodiments, the power of each audio channel or waveform may correspond to an energy level thereof, a Signal-to-Noise Ratio (SNR) thereof, a singer-to-musical instruments ratio, a whisper-to-ambient noise ratio, or the like.

In some exemplary embodiments, Enhancement Process 410 may be configured to estimate a speech rate of each audio channel or waveform, a subset thereof (e.g., the speech channel), or the like. For example, as part of Stage 412, Enhancement Process 410 may estimate a speech rate of each of Speech Component 401. In some exemplary embodiments, Enhancement Process 410 may deploy one or more ASR modules, components thereof, or the like, in order to estimate the speech rate of the acoustic components.

In some exemplary embodiments, Enhancement Process 410 may be configured to classify the acoustic components into an auditory scene such as music, conversation, or the like. For example, the auditory scene may be estimated as part of Stage 413. In some exemplary embodiments, Enhancement Process 410 may be configured to obtain a plurality of class scores, such as class scores determined on FIG. 3B, and utilize them for estimating a most likely auditory scene, e.g., a highest scoring class of auditory scenes, a most likely auditory scene in view of past classifications, or the like.

In some exemplary embodiments, on Stage 415, Enhancement Process 410 may be configured to obtain a Mode Identifier (ID) 414, which may indicate a mode associated with one or more predetermined population segments. In some exemplary embodiments, Mode ID 414 may define one or more hearing requirements, hearing capabilities, hearing preferences, or the like, associated with a population segment. For example, Mode ID 414 may define, for a specific population segment, that in a first auditory scene the recommended speech rate is below a first speech rate, and for a second auditory scene the recommended speech rate is below a second speech rate.

In some cases, Enhancement Process 410 may obtain a plurality of modes of a plurality of population segments, and process them in a single processing. In some cases, Enhancement Process 410 may obtain each mode of a population segment separately, and process the modes separately for each population segment.

In some exemplary embodiments, on Stage 415, Enhancement Process 410 may be configured to determine, based on the obtained Mode ID 414, the classified auditory scene, and the measured power of each acoustic component, one or more construction logic components. In some exemplary embodiments, the construction logic components may comprise one or more processing or assembly instructions for each audio component, each waveform of Acoustic Components 307 (FIG. 3A), or the like. For example, Enhancement Process 410 may generate one or more instructions for modifying each of the plurality of acoustic components, based on the Mode ID 414, the measured power of each audio channel, the estimated speech rate of the speech channel (Speech Component 401), the classified auditory scene, or the like.

In some exemplary embodiments, the generated instruction may comprise instructions to modify a speech rate of one or more acoustic components, e.g., of Speech Component 401. For example, based on the estimated speech rate determined at Stage 412, and based on speech rate requirements indicated by Mode ID 414 for the current auditory scene, Enhancement Process 410 may determine a rate of reduction of the current speech rate, e.g., denoted α.

In some exemplary embodiments, the generated instruction may comprise instructions to apply determined acoustic weights on respective acoustic components. In some exemplary embodiments, Enhancement Process 410 may be configured to determine a plurality of acoustic weights for the acoustic components, respectively, based on ratio preferences indicated by Mode ID 414 for the current auditory scene. In some cases, Mode ID 414 may indicate one or more preferred ratios between acoustic components, such as a ratio between certain musical instruments to other musical instruments, a preferred loudness dynamic range, a preferred ambience, a preferred background to noise ratio, or the like. For example, the instructions may comprise denoted acoustic weights ω₁, ω₂, and ω₃, which may be configured to be applied by multiplication to the respective separated audio waveforms, e.g., Speech Component 401, Music Component 402, and Sound Effects Component 403.

In some exemplary embodiments, the generated instruction may comprise instructions to apply one or more latency reduction techniques, to one or more separated audio waveforms, e.g., Speech Component 401, Music Component 402, and Sound Effects Component 403. For example, Instructions 440 may instruct to accelerate or drop one or more sections of Music Component 402 and/or Sound Effects Component 403. In some cases, such as in case a time-lag is considered acceptable, Instructions 440 may not be generated.

In some exemplary embodiments, slowing down the time scale of the speech segments may adversely affect a synchronization between the different acoustic components. For example, slowing down Speech Component 401 may cause the Speech Component 401 to not be synchronized with Music Component 402 and Sound Effects Component 403 in the output Audio Signal 437 provided to the user. In some exemplary embodiments, in order to reduce the aggregated delay, the relative delay between Speech Component 401 and other channels, overcome the synchronization issues, or the like, non-voice segments such as portions of Music Component 402 and Sound Effects Component 403 may be dropped or accelerated. In some cases, one or more non-voice segments that are consecutive, or interleaved between voice segments in the time axis, may be dropped or accelerated until the aggregated delay is eliminated, reduced to less than a threshold, or the like. In some exemplary embodiments, since non-voice segments may, in some cases, be non-silent, accelerating the non-voice segments may be useful to avoid losing information that could be perceived by the target user, compared to dropping the non-voice segments entirely.

In some exemplary embodiments, during Stage 415, the determined instructions may be provided to Enhancement Process 420. For example, speech rate instructions may be provided to Stage 423, the acoustic weight instructions may be provided to Stage 422, and Instructions 440 may be provided to Stage 421. In other cases, the instructions may be provided to any other components or stages of Enhancement Process 420.

In some exemplary embodiments, Enhancement Process 420 may be configured to obtain a plurality of acoustic components, such as Speech Component 401, Music Component 402, and Sound Effects Component 403, e.g., similarly to Enhancement Process 410.

In some exemplary embodiments, during Stage 421 of Enhancement Process 420, Instructions 440 may be obtained from Enhancement Process 410, e.g., from Stage 415. In some exemplary embodiments, during Stage 421, the acoustic components or subset thereof may be adapted according to Instructions 440. For example, one or more sections of Music Component 402 and/or Sound Effects Component 403 may be accelerated or dropped according to Instructions 440. In some exemplary embodiments, Instructions 440 may be implemented by applying at least one digital filter or process that may be used to accelerate or drop one or more audio sections according to Instructions 440. For example, ASR processing may be applied to accelerate non-voice segments, in order to reduce an aggregate delay caused by previous slowed-down speech segments, currently slowed-down speech segments, or the like.

In some exemplary embodiments, during Stage 421, the acoustic components may be enhanced or processed in one or more manners. For example, the acoustic components may be processed by applying an Enhancement and Equalization (EE) Filtering, one or more Infinite Impulse Response (IIR) band pass filters, a Low-Pass Filter (LPF), compression audio processes, mask reduction audio processes, or any other digital filter or process that may be used to accelerate or drop one or more audio sections according to Instructions 440. For example, a LPF may be applied on Speech Component 401. As another example, a reverberation of Sound Effects Component 403 may be reduced, such as according to one or more audio equalization techniques disclosed in Välimäki, V.; Reiss, J. D. All About Audio Equalization: Solutions and Frontiers. Appl. Sci. 2016, 6, 129, which is hereby incorporated by reference in its entirety without giving rise to disavowment.

In some exemplary embodiments, a processed version of the acoustic components, having adjusted acoustic parameters, may be provided from Stage 421 to Stage 422, to be processed thereby. In some exemplary embodiments, during Stage 422, a plurality of acoustic weights for the acoustic components, e.g., denoted ω₁, ω₂, and ω₃, may be obtained from Enhancement Process 410, and applied on respective acoustic components. For example, a mixer may be configured to apply the acoustic weights ω₁, ω₂, and ω₃ to Speech Component 401, Music Component 402, and Sound Effects Component 403, respectively. For example, in one scenario, the sound intensity of the low frequencies characterizing bass sounds may be increased relative to higher frequencies of a guitar.

In some cases, the mixer may mix the plurality of weighted waveforms into a single audio waveform. In some exemplary embodiments, a weighted mixed audio signal may be provided from Stage 422 to be processed by Stage 423. In other cases, the plurality of weighted waveforms may be provided to Stage 423.

In some exemplary embodiments, during Stage 423, the determined rate of reduction of the speech rate may be obtained from Enhancement Process 410, e.g., as a scale parameter, and the mixed audio signal may be processed accordingly. In some exemplary embodiments, during Stage 423, a Time Scale Modification (TSM) may be applied to the weighted mixed audio signal, such as for adapting the speech rate according to the instructions from Enhancement Process 410. For example, Stage 423 may employ ASR processing, for adapting the speech rate according to the obtained scale parameter, e.g., denoted α. According to this example, the scale parameter utilized by TSM may be \acute{α}=α·relFactor, where a is an initially computed scale parameter, and relFactor is a relative factor used to modify a in view of the current or estimated time-lag.

In some cases, the ASR processing may be applied on a single audio signal, e.g., the weighted mixed audio signal from Stage 422, and the time scale modification may be applied uniformly on the entire signal. In some cases, the ASR processing may be applied on voice segments, such as Speech Component 401, without applying ASR processing on other acoustic components. For example, voice segments may be modified to slow down the signal (e.g., using a multiplier that is lesser than one, such as in case of α<1), while for non-voice segments (e.g., segments corresponding to Music Component 402 and Sound Effects Component 403), the time scale may remain unchanged during Stage 422. As another example, voice segments may remain unchanged in case of a multiplier that is equal to one such as in case of α=1. As another example, voice segments may be accelerated in case of a multiplier that is greater than one such as in case of α>1.

In some exemplary embodiments, Stage 423 may provide, as an output, a processed Audio Signal 437 that is assembled according to instructions from Enhancement Process 410. In some exemplary embodiments, Audio Signal 437 may be provided, or designated, to end devices that correspond to the user segment of Mode ID 414.

Referring now to FIG. 4B, depicting an exemplary schematic block diagram, in accordance with some exemplary embodiments of the disclosed subject matter.

In some exemplary embodiments, FIG. 4B may depict a schematic block diagram of Audio Enhancement Processes 491, which may correspond to Audio Enhancement Processes 400 of FIG. 4A. In some cases, Audio Enhancement Processes 491 may differ from Audio Enhancement Processes 400 in one or more manners.

In some exemplary embodiments, as depicted in FIG. 4B, during Stage 421 of Enhancement Process 420, Instructions 440 may be obtained and applied on the audio signal, along with one or more other processing or filtering techniques. Instead of providing all the acoustic components as separate channels to Stage 422, as performed in FIG. 4A, Stage 421 may provide only non-speech segments to Stage 422, and provide Speech Component 401 to Stage 423, for adapting its speech rate. For example, this may enable Stage 423 to be performed in parallel to some of the computations of Stage 422. In some exemplary embodiments, after Stage 423 adapts the speech rate of Speech Component 401, the adapted Speech Component 401 may be provided to Stage 422 for applying acoustic weights thereto (e.g., after weights were applied to the non-speech segments). In other cases, Enhancement Process 420 may be organized, scheduled, or performed, in any other order.

Referring now to FIG. 5, depicting an exemplary ASR module, in accordance with some exemplary embodiments of the disclosed subject matter.

In some exemplary embodiments, ASR Module 500 may be implemented within the framework of Block Diagram 200 of FIG. 2, such as within EEL Module 230 and/or AEE Module 240 of FIG. 2. In some exemplary embodiments, ASR Module 500 may be implemented within Enhancement Process 410 and/or Enhancement Process 420 of FIGS. 4A-4B. For example, ASR Module 500 may be implemented, at least in part, within Stages 412, 415, and/or 423 of FIGS. 4A-4B. For example, ASR Module 500 may be used to estimate speech rates, to determine adjustments thereto, and to apply adjustments thereto.

In some exemplary embodiments, ASR Module 500 may be implemented as a stand-alone module. For example, ASR Module 500 may be implemented as a stand-alone module that may be installed and executed on an end device such as a smartphone, a mobile phone, a laptop, a Personal Computer (PC), wearables, a tablet, an end device, or the like. In other cases, ASR Module 500 may be integrated or embedded within the processes of FIGS. 4A-4B.

In some exemplary embodiments, one or more processes or subprocesses of the ASR Module 500 may be implemented in parallel, e.g., using multi-threads, such as in order to save computational time, to maintain real-time rates for real-time scenarios, or the like.

In some exemplary embodiments, ASR Module 500 may be associated to a “Listener” entity that utilizes a speaker, and/or to a “Talker” entity that utilizes a microphone. For example, a user constituting both the “Listener” and “Talker” entities, may utilize a speaker to hear processed audio and a microphone to speak (e.g., in a video conference). In some cases, the speaker may comprise a speaker of a hearing device or an end device of the user. In some exemplary embodiments, ASR Module 500 may process Rx Audio 551 and provide a processed version thereof, Output Signal 537, to the user's speaker. In some cases, ASR Module 500 may process Speech 558 from the “Talker” entity, as captured by the microphone, and provide a processed version thereof, e.g., Tx Audio 557, to replace Speech 558 (e.g., to participants in the video conference).

In some exemplary embodiments, ASR Module 500 may comprise one or more components for performing speech rate estimation (e.g., within Stage 412 of FIGS. 4A-4B), for determining speech rate adjustments, and for applying speech rate adjustments. In some exemplary embodiments, ASR Module 500 may obtain a received audio channel, e.g., Rx Audio 551, which may correspond to a plurality of separate acoustic components, a single combined signal, or to Speech Component 401 (FIGS. 4A-4B). For example, Rx Audio 551 may comprise a target sound such as sound segments of a movie presented in the cinema, speech audio waveform of a live event, speech segments of a person with which the user is conversing (e.g., in a video conference), or the like.

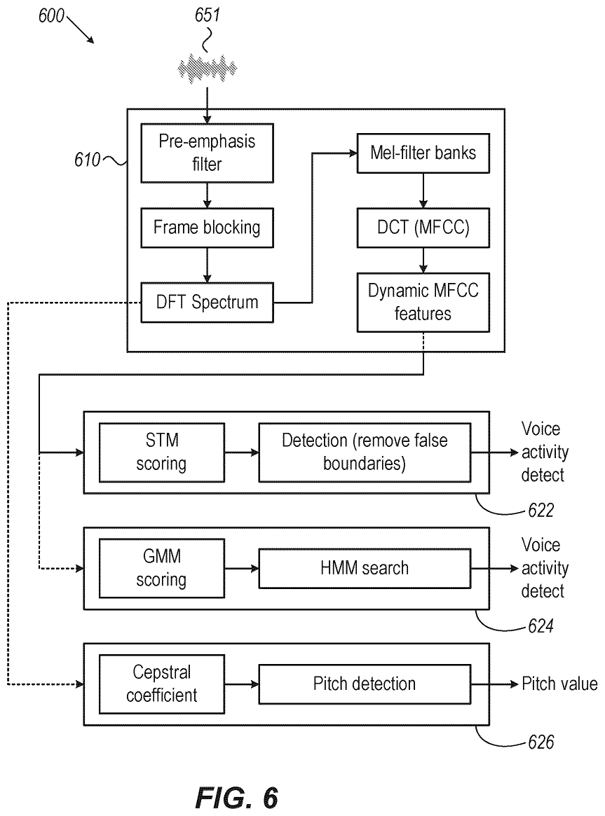

In some exemplary embodiments, ASR Module 500 may process Rx Audio 551 using one or more modules, subprocesses, or the like. In some exemplary embodiments, ASR Module 500 may comprise a Voice Activity Detection (VAD) Subprocess 554, which may be configured for classifying small-time sound packets of Rx Audio 551 as either containing voice (V) or not containing voice (No-Voice (NV)). For example, Classification 555 may classify defined segments or portions of Rx Audio 551 as containing voice or not containing voice, e.g., in real-time scenarios, in offline scenarios, or the like. In some cases, VAD Subprocess 554 may comprise a predictor that is trained on a labeled dataset of sounds labeled as V or NV, a classifier that is not data-driven, one or more components of FIG. 6, or the like. In some cases, predictors that are computationally heavy and more accurate may be used for offline scenarios, while computationally lighter predictors that are less accurate may be used for real-time scenarios.

In some exemplary embodiments, VAD Subprocess 554 may be configured to classify a sound packet regardless of its sound intensity. For example, a sound packet classified as not containing any voice, or NV, may comprise sounds that are below a sound intensity threshold (e.g., an intensity threshold of 55 dB Sound Pressure Level (SPL), 50 dB SPL, 40 dB SPL, 30 dB SPL, 20 dB SPL, or the like), sound that are louder than the sound intensity threshold, or the like, as long as the audio sounds do not comprise speech components.

In some cases, the small-time packets may comprise segments or packets of a defined time window such as 10 ms, 50 ms, or the like. In some exemplary embodiments, VAD Subprocess 554 may perform the classification every time duration, which may not necessarily correspond to the analyzed time window. For example, the classification may be performed every time duration of 5 ms, 10 ms, 15 ms, or the like, while a time window of sound that is analyzed may be greater, e.g., 25 ms, 50 ms, or the like. According to this example, in case the time duration is 10 ms, and the window duration is 25 ms, a set of features may be extracted from a window of 25 ms of data centered around the current frame every 10 ms, and used for Classification 555. In other cases, any other ratio between the time duration and time window may be applied, e.g., the time window being lesser than or equal to the time duration.

In some exemplary embodiments, after VAD Subprocess 554 starts or finishes to process Rx Audio 551, a subprocess such as Speech Analysis and Rate Estimation (SARE) Rx (SARE_{Rx}) 552 may be applied on Rx Audio 551, such as in order to estimate a rate of speech of Rx Audio 551. For example, SARE_{Rx} 552 may be applied on Rx Audio 551 in case VAD Subprocess 554 classifies at least portion thereof as speech. In some exemplary embodiments, SARE_{Rx} 552 may provide its estimated speech rate (denoted R_{Rx}) to Call Control (CC) 559.

In some exemplary embodiments, CC 559 may determine, based on the obtained estimation of speech rate of Rx Audio 551, valuations of one or more scale parameters that adjust the time scale of Rx Audio 551. It is noted that scale parameters may refer to any parameter that relates to a speech rate, such as a target pace of speech, a constraint or limit on a speech rate, parameters useful for reducing or increasing a speech rate, parameters indicating an existing speech rate, or the like. In some exemplary embodiments, CC 559 may be configured to determine values of the scale parameters that match the hearing needs of predetermined population segments, for the current auditory scene. In some exemplary embodiments, CC 559 may determine different scale parameters for different population segments. In some exemplary embodiments, CC 559 may determine scale parameters based on environmental parameters, such as background noise, an SNR, a pace of Speech 558 of the user, or the like, e.g., in real-time, offline, or the like.

For example, a scale parameter may be determined in view of a hearing configurations of a population segment that corresponds to an auditory scene of an action movie scene. As another example, CC 559 may determine a scale parameter that slows down the speech rate of Rx Audio 551 so that it matches the hearing rate that is desired by the user segment, although this may create a delay.

In some exemplary embodiments, CC 559 may estimate an aggregated time-lag, e.g., which may be estimated in view of a measured time-lag between Rx Audio 551 and a previous output (Output Signal 537), in view of the determined scale parameters, in view of previously applied scale parameters, in view of a measured time-lag between Rx Audio 551 and a previously processed audio input in the time axis, or the like.

In some exemplary embodiments, CC 559 may be configured to adjust the values of the scale parameters to adhere to a maximal time-lag threshold, so as to allow the system to be used in real-time, to prevent lip sync issues, or the like. In some cases, the maximal time-lag threshold may be 1000 ms, 800 ms, 600 ms, 500 ms, 400 ms, or the like. In some cases, in case CC 559 detects that the aggregated time-lag reaches the maximal time-lag threshold, CC 559 may prevent additional slowing-down of the speech channel, such as by not providing additional values of the scale parameters that slow down the speech rate (α<1). In some exemplary embodiments, CC 559 may determine a relative factor for adjusting or factorizing the scale parameters, e.g., based on a current accumulated time-lag. For example, the relative factor may be multiplied with the scale parameter, and thereby adjust the scale parameters in accordance with the time-lag.

In some cases, in case CC 559 detects that the aggregated time-lag reaches (or is estimated to reach) the maximal time-lag threshold, CC 559 may determine whether or not one or more segments of Rx Audio 551 should be accelerated, sped up, skipped, or the like. For example, CC 559 may make a determination to skip a time segment, e.g., a time segment classified as an NV time segment by VAD Subprocess 554, to reduce the accumulated time-lag. In some cases, CC 559 may make a determination to accelerate a time segment, e.g., an NV time segment, for non-voice segments, so as to reduce the accumulated time-lag.

In case CC 559 operates in an offline manner, instead of in a real-time manner, CC 559 may not necessarily adhere or be bound to the maximal time-lag threshold. For example, in case of an audio-only media, such as a podcast, no latency thresholds may be required to be complied with, as there may not be any synchronization issues or lip-sync issues. In some offline scenarios, such as for visual media scenarios, CC 559 may allow for an increased offset (e.g., an increased time-lag threshold) of the speech channel (compared to real-time scenarios), which may also include a negative offset as well as a positive offset. For example, since the offline scenarios are not deterministic in the time axis, CC 559 may permit an increased offset between negative and positive aggregated time-lag thresholds such as: [−threshold, +threshold], going back and forward in the time axis. In such cases, CC 559 may be enabled to reduce the pace of the speech channel up to the negative time-lag threshold before the original speech, and up to the positive time-lag threshold after the original speech. For example, a range of offline time-lag thresholds such as [−2,1] may indicate that a negative time-lag threshold of up to 2 seconds or other time units is permissible, enabling to reduce the speech rate to 2 second before the original speech, while a positive time-lag threshold of up to 1 second or other time unit is acceptable, enabling to reduce the speech rate to 1 second after the original speech. According to this example, the overall offset may comprise 3 seconds, including 2 negative seconds and 1 positive second. In real-time scenario, on the other hand, only positive time-lag thresholds may be used due to the deterministic nature of the time axis in real-time processing, resulting with a decreased overall offset relative to the offline processing. For example, offline processing may allow for a range of acceptable time lag thresholds that is twice that of real-time processing, e.g., due to the negative offset.

In some exemplary embodiments, CC 559 may provide the calculated values, such as the values of the scale parameters, the relative factor, the acceleration parameters, or the like, to Time Scale Modification (TSM) Rx (TSM_{Rx}) Stage 523, to be applied on Rx Audio 551. For example, the determined scale parameter values may correspond to the rate of reduction of the speech rate, denoted as a in FIGS. 4A-4B.

In some exemplary embodiments, TSM_{Rx} Stage 523 may obtain from CC 559 the scale parameters, the relative factor, the acceleration parameters, the received audio, e.g., Rx Audio 551, or the like, and adjust Rx Audio 551 accordingly. For example, the time scale of Rx Audio 551 may be adjusted from the original speech rate determined by SARE_{Rx} 552, to a target speech rate resulting from applying the obtained parameters. In some exemplary embodiments, TSM_{Rx} Stage 523 may output an enhanced version of Rx Audio 551, e.g., Output Signal 537, that matches hearing needs of one or more user segments, that reduces a time lag, or the like, as determined by CC 559.

In some exemplary embodiments, in case of a transmitted speech of the user, e.g., Speech 558, the recorded audio channel captured by the microphone may be first provided to VAD Subprocess 554 for determining whether it includes speech segments. In some cases, SARE may be applied bidirectionally, e.g., in case of a two-sided conversation or interaction in which the user is an active speaker. In some exemplary embodiments, in case Speech 558 is determined to contain a voice, Speech 558 may be provided to SARE Tx (SARE_{Tx}) 553 to estimate the speech rate of the user's speech. For example, in addition to estimating the speech rate of Rx Audio 551, SARE may be used to estimate the speech rate of the user's speech, e.g., Speech 558. For example, the different speech rates of Rx Audio 551 and Speech 558 may be estimated by SARE_{Rx} 552 and SARE_{Tx} 553 simultaneously, at different times, at overlapping times, or the like.

In some exemplary embodiments, the measured speech rate of the user may be useful for calculating the scale parameter for Rx Audio 551. In some exemplary embodiments, during a conversation between two people with different speech rates (e.g., where one is a “slow-talker” and the other is a “fast-talker”), a psychological effect may act on the fast-talker, causing them to reduce their speech rate, e.g., as shown in Gabay, Y.; Najjar, I J, and Reinisch, E. Another temporal processing deficit in individuals with developmental dyslexia: The case of normalization for speaking rate, Journal of Speech, Language, and Hearing Research, Vol. 62, pages 2171-2184. (July 2019). In some exemplary embodiments, CC 559 may exploit the psychological effect and adjust the scale parameters for Rx Audio 551 to accommodate the hearing needs of the user, e.g., as indicated by the measured speech rate of the user. For example, the psychological effect may cause the fast speaker with which the user is speaking, to adapt their speech rate to the hearing pace of the user.

In some exemplary embodiments, after applying SARE_{Tx} 553, the determined speech rate of Speech 558 (denoted R_{Tx}) may be provided to CC 559. In some exemplary embodiments, CC 559 may utilize the determined speech rate of Speech 558 for its calculations, such as for calculating scale parameters for Output Signal 537. In some cases, CC 559 may provide the scale parameters to be applied on Speech 558 by TSM Tx (TSM_{Tx}) Stage 524. For example, the scale parameters for Speech 558 may be different or identical to the scale parameters that were determined for Output Signal 537. In some cases, TSM_{Tx} Stage 524 may adjust the speech rate of Speech 558 according to the scale parameters. For example, while TSM_{Rx} Stage 523 may adjust Rx Audio 551 according to first scale parameters denoted as α_{Rx}, TSM_{Tx} Stage 524 may adjust Speech 558 according to second scale parameters denoted as α_{Tx}.

Referring now to FIG. 6, depicting an exemplary schematic block diagram, in accordance with some exemplary embodiments of the disclosed subject matter.

In some exemplary embodiments, Block Diagram 600 may depict blocks, each of which represents a component, stage, subprocess, or subsystem of the disclosed subject matter, and interconnections between the blocks may illustrate how these components interact or are related in terms of functionality or information flow. In some exemplary embodiments, one or more of the blocks may be implemented in parallel, in overlapping timeframes, or the like, in order to maintain real-time rates.

In some exemplary embodiments, Block Diagram 600 may be implemented as part of ASR Module 500 of FIG. 5. For example, Block Diagram 600 may be implemented as within VAD Subprocess 554 of FIG. 5.

In some exemplary embodiments, Block Diagram 600 comprise a pipeline for speech rate estimation. In some exemplary embodiments, the pipeline may be based on one or more methods disclosed in Aharonson, V., Aharonson, E., Raichlin-Levi, K., Sotzianu, A., Amir, O., & Ovadia-Blechman, Z. A real-time phoneme counting algorithm and application for speech rate monitoring. Journal of fluency disorders, 51, 60-68. (2017), which is hereby incorporated by reference in its entirety without giving rise to disavowment.

For example, the pipeline of Block Diagram 600 may start with obtaining an input signal, e.g., Input Audio 651, which may correspond to Rx Audio 551 of FIG. 5. For example, Input Audio 651 may comprise a Pulse Density Modulation (PDM) signal, a Pulse Code Modulation (PCM) signal, or the like, e.g., an 8-bit PCM signal, a 16-bit PCM signal, or any other sized signal. Input Audio 651 may be sampled at a frequency of 8 kilohertz (kHz), 16 kHz, 32 kHz, or the like.

In some cases, features from Input Audio 651 may be extracted by applying one or more subprocesses of Feature Extraction 610. For example, Input Audio 651 may be processed by pre-emphasis filtering (e.g., high-pass filtering), a framing subprocess (e.g., dividing Input Audio 651 into segments or frames), a spectral analysis subprocess (e.g., for converting Input Audio 651 from a time domain to a frequency domain using Discrete Fourier Transform (DFT), Fast Fourier Transform (FFT), Short-Time Fourier Transform (STFT), or the like), Mel-frequency analysis (e.g., extracting features by applying a set of triangular filters spaced evenly in the Mel-frequency scale), cepstral analysis (e.g., for converting the Mel-filter bank energies into MFCCs using Discrete Cosine Transform (DCT)), and a delta features subprocess (e.g., capturing the temporal dynamics of the MFCCs as the first-order differences (delta) and/or second-order differences (delta-delta) of the static MFCCs). As another example, one or more of the above subprocesses may be applied in any other order.

In other cases, any other subprocesses may be used for extracting informative features from Input Audio 651, instead of in addition to the above subprocesses. For example, a pre-trained neural network implemented in the input layers of an MFCC may be trained to extract features for a rate estimation model.

In some exemplary embodiments, one or more pattern recognition modules may be utilized by Feature Extraction 610, independently thereof, or the like. For example, Modules 622, 624, and 626 may be utilized for pattern recognition, and based thereon, a determination of whether Input Audio 651 includes speech may be made. In some exemplary embodiments, Modules 622, 624, and 626 may comprise one or more deep-learning algorithms, neural network classifiers, data-driven modules such as CNN, a Recurrent Neural Network (RNN), a Residual Neural Network (ResNet), a Transformer, and a Conformer, heuristic-based modules, or the like. For example, a speech rate estimation algorithm, including pattern recognition modules, may be implemented with a neural network architecture for achieving a time-efficient algorithm.

In some cases, Module 622 may be configured to improve the accuracy of speech/non-speech segmentation. In some cases, Module 622 may obtain dynamic MFCC features from the delta features subprocess, and apply a Short-Term Memory (STM) scoring module, a boundary detection, and a false boundaries detection module for removing false boundaries between speech and non-speech segments, or the like. For example, one or more post-processing algorithms, smoothing filters, or thresholding methods may be used to refine the speech/non-speech segmentation and remove false boundaries, which may be used for voice activity detection.

In some cases, Module 624 may obtain dynamic MFCC features from the delta features subprocess, and apply a Gaussian Mixture Model (GMM) scoring and a Hidden Markov Model (HMM) search, to find the most likely sequence of phonemes or vowels given the observed dynamic MFCC features. In some cases, based on the results of the HMM search, Module 624 may determine the count and identity of vowels or phonemes present in the speech signal, which may be used for voice activity detection.

In some cases, Module 626 may obtain a frequency domain representation of Input Audio 651 from the spectral analysis subprocess, and apply thereon a cepstral coefficient analysis and a pitch detection subprocess. For example, the pitch detection subprocess may be configured to estimate the fundamental frequency (pitch) of the audio signal, which corresponds to the perceived pitch of a sound. In some cases, a pitch value outputted from the pitch detection subprocess may provide information about the perceived pitch of Input Audio 651, which may be useful for speech audio analysis such as voice activity detection.

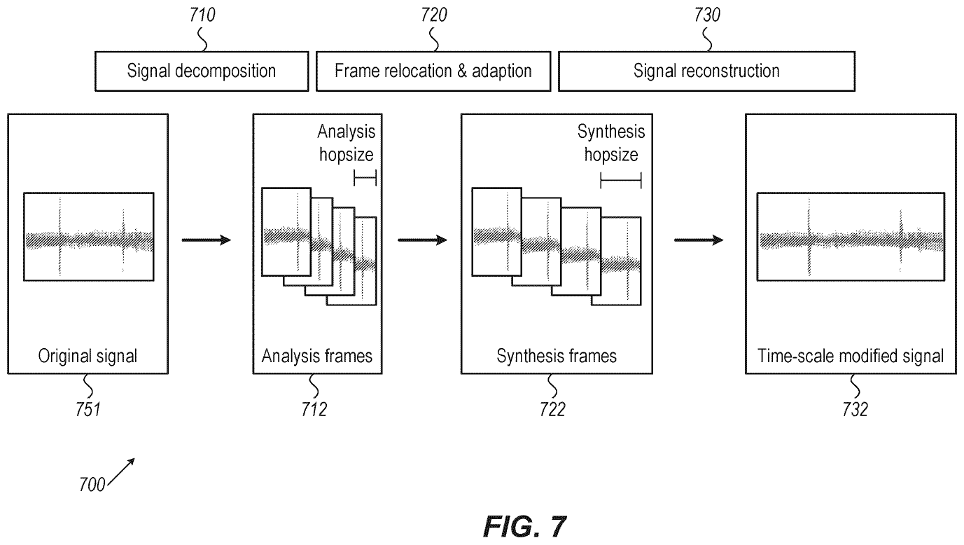

Referring now to FIG. 7, depicting an exemplary process of adapting a speech rate, in accordance with some exemplary embodiments of the disclosed subject matter.

In some exemplary embodiments, Process 700 may implement a TSM module, such as TSM_{Rx} Stage 523 and/or TSM_{Tx} Stage 524 of FIG. 5. For example, Process 700 may be implemented as within TSM_{Rx} Stage 523 of FIG. 5, and may be used for adapting the speech rate of Rx Audio 551.

In some exemplary embodiments, Process 700 depicts a pipeline that may correspond to one or more speech rate adaption techniques disclosed in Driedger, J.; Müller, M. “A Review of Time-Scale Modification of Music Signals”. Appl. Sci. 2016, 6, 57, which is hereby incorporated by reference in its entirety without giving rise to disavowment. In other cases, Process 700 may correspond to any other speech rate adaption technique.

In some exemplary embodiments, the pipeline of Process 700 may start with Input Audio 751 (corresponding to Input Audio 651 of FIG. 6) being obtained. In some cases, in addition to Input Audio 751, one or more additional inputs may be obtained such as the VAD's classification of voice or no-voice for one or more time segments of Input Audio 751, a scale parameter for adjusting speech rate, a parameter for factorizing the scale parameter, or the like. For example, the parameter for factorizing the scale parameter may indicate a number of quiet samples in Input Audio 751 that may be omitted or accelerated in order to compensate for a latency from the scale parameters.

In some exemplary embodiments, Input Audio 751 may be processed by Signal Decomposition 710, and split into short frames with a fixed length of 20 ms, 50 ms, 100 ms, 200 ms, or the like, of audio material. For example, the short frame may correspond to Analysis Frames 712. In some exemplary embodiments, each frame may capture the local pitch content of Input Audio 751.

In some exemplary embodiments, after Signal Decomposition 710 is applied, Analysis Frames 712 may be provided to Frame Relocation and Adoption 720, which may be configured to relocate Analysis Frames 712 on the time axis to achieve a time-scale modification of Input Audio 751, while, at the same time, preserving the pitch of Input Audio 751. For example, Frame Relocation and Adoption 720 may output Synthesis Frames 722.

In some exemplary embodiments, after Frame Relocation and Adoption 720 is applied, Synthesis Frames 722 may be provided to Signal Reconstruction 730, which may be configured to superimpose Synthesis Frames 722 in order to reconstruct a time-scale modified output signal, e.g., Time-Scale Modified Signal 732. In some exemplary embodiments, Time-Scale Modified Signal 732 may have an adapted speech rate compared to Input Audio 751.

In some exemplary embodiments, Signal Decomposition 710, Frame Relocation and Adoption 720, and Signal Reconstruction 730 may be applied on Input Audio 751 in real time, e.g., under a real-time latency threshold.

Referring now to FIG. 8A showing a schematic illustration of an exemplary scenario in which the disclosed subject matter may be utilized, in accordance with some embodiments of the disclosed subject matter.

In some exemplary embodiments, Environment 800 may comprise one or more end users, e.g., Users 841, 842, 843, and 844. In some exemplary embodiments, the end users may utilize end devices, some of which may be registered to the service of the disclosed subject matter. For example, User Devices 851, 852, and 853 may be utilized by Users 841, 842, and 843, respectively, and may be registered to a software application, processing box, or service of enhancing audio signals, as provided by implementing the disclosed subject matter. In some exemplary embodiments, User Devices 851, 852, and 853 may comprise one or more smartphones, mobile devices, hearables, laptops, smart televisions, PCs, or the like.

In some exemplary embodiments, registered users, such as Users 841, 842, and 843, may define their hearing needs, preferences, or the like, via a user interface of User Devices 851, 852, and 853, directly, indirectly, or the like. For example, Users 841, 842, and 843 may belong to one or more user segments with defined hearing capabilities, preferences, or the like. In other cases, registered users may define their hearing needs, preferences, or the like, via a user interface of any other device, e.g., a user interface of Processing Box 820.

In some exemplary embodiments, User Devices 851, 852, and 853 may execute a dedicated software application to which enhanced audio may be provided. In some exemplary embodiments, User Devices 851, 852, and 853 may execute a third-party software application that may have access to enhanced audio via an API, e.g., by performing API calls. In some cases, User Devices 851, 852, and 853 may locally process obtained audio channels and generate enhanced audio for the respective users.

In some exemplary embodiments, User Devices 851, 852, and 853 may enable to provide audio output to a user, such as directly via speakers of User Devices 851, 852, and 853, or indirectly via hearing equipment such as earbuds. For example, earbuds of Users 841, 842, and 843 may be wired or paired with each of User Devices 851, 852, and 853. In some exemplary embodiments, the hearing equipment may communicate with User Devices 851, 852, and 853 via one or more communication protocols such as Low Energy (LE)-audio, Bluetooth™, Auracast™, WIFI™, short range wireless techniques, long range wireless communications, Infrared communications, cellular communications, wired communications, physical connection protocols such as Lightning™, Type-C communications, or the like. In some cases, audio output may not be provided to Users 841, 842, and 843 from User Devices 851, 852, and 853, and instead, audio output may be provided by another device, e.g., a public media provider.

In some exemplary embodiments, Environment 800 may comprise one or more sound sources, and Users 841, 842, and 843 may desire to obtain a processed version of the sound sources that matches their hearing needs, preferences, or the like. For example, Environment 800 may comprise a movie theatre, and a displayed movie may correspond to the sound source, e.g., in case the users desire to hear the soundtrack of the movie. According to this example, Storage 805 may store or retain audio and video information of the movie, e.g., by a computing device of the movie theatre. In some exemplary embodiments, the audio and video information may be sourced, or provisioned, from Storage 805 to one or more media providers, such as Audio Provider 810 and Video Provider 830.

In some exemplary embodiments, Video Provider 830 may present or display the video on a displaying device, such as Screen 835, e.g., according to the video information from Storage 805. In some exemplary embodiments, Audio Provider 810 may be configured to provision the soundtrack, e.g., stereo audio, mono audio, or the like, to a set of one or more speakers, such as Speaker 815. For example, Audio Provider 810 may comprise an audio console that is configured to provide the soundtrack to the audience using Speaker 815.

In some exemplary embodiments, after the movie information is retrieved from Storage 805 and implemented by Speaker 815 and Screen 835, via Audio Provider 810 and Video Provider 830, the audience in the movie theatre may be enabled to watch the movie and hear the respective soundtrack. For example, User 844 may not be registered to the service of Processing Box 820, and may be enabled to experience the original soundtrack, as provided by Speaker 815.

In some exemplary embodiments, one or more people in the audience in the movie theatre may be registered to a service of obtaining a processed version of the movie soundtrack in a manner that matches their hearing needs, preferences, or the like. For example, users that are hard of hearing may desire to obtain the sound in a slowed down speech version, in an amplified version, in an enhanced or different frequency, or the like.

In some exemplary embodiments, Users 841, 842, and 843 may register to Processing Box 820, via User Devices 851, 852, 853, using Registration Module 825. For example, Registration Module 825 may be stored on a remote server, within a local Processing Box 820, or the like, and may comprise an executable software module. In some exemplary embodiments, Registration Module 825 may enable users to register to a specific audio variation, based on indicated user preferences, based on a user segment associated directly or indirectly to the user, or the like. For example, Registration Module 825 may enable a user to indicate a customized audio variation based on personal hearing capabilities of the respective user. As another example, Registration Module 825 may enable a user to indicate their personal hearing capabilities, and may determine based thereon a population segment that matches the user and has determined hearing configurations. As another example, Registration Module 825 may classify a user to a specific population segment, without requiring direct user input.

In some exemplary embodiments, the soundtrack of the movie may be captured, in order to process it for the registered users. In some exemplary embodiments, the soundtrack may be captured by connecting a processing device, such as Processing Box 820, to Audio Provider 810, thereby obtaining the audio of the movie directly. For example, Processing Box 820 may obtain stereo signals, mono signals, or the like, directly or indirectly from Audio Provider 810. In other case, the soundtrack of the movie may be captured in any other way, from any other device. For example, microphones of Processing Box 820 may record the sound in the environment, thereby capturing the soundtrack of the movie.

It is noted that Processing Box 820 may comprise a local computing device that is close proximity to the users, to the sound source, or the like, or a computing device that is at least partially remote. For example, a local portion of Processing Box 820 may be physically connected to Audio Provider 810, and provide the obtained soundtrack for processing at a remote server.

In some exemplary embodiments, after capturing the soundtrack of the movie, Processing Box 820 may apply one or more processing modules on the soundtrack, such as according to hearing variations of registered users. In some exemplary embodiments, Processing Box 820 may process the audio signal according to any of the processing modules of FIG. 2, sub-modules thereof (e.g., modules of FIGS. 3A-7), or the like. In some exemplary embodiments, Processing Box 820 may implement a plurality of audio processing modules, e.g., modules of Block Diagram 200 of FIG. 2, Source Separation 300 of FIG. 3A, Content Classification 302 of FIG. 3B, Audio Enhancement Processes 400 of FIG. 4A, Audio Enhancement Processes 491 of FIG. 4B, ASR Module 500 of FIG. 5, modules of Block Diagram 600 of FIG. 6, modules of Process 700 of FIG. 7, or the like. In other cases, the processing may be distributed to end devices such as User Devices 851, 852, and 853, in which case the end devices may implement at least some of the processing modules of FIGS. 2-7.

In some exemplary embodiments, Processing Box 820 may process and modify the original soundtrack into a set of one or more alternative audio channels. For example, one alternative audio signal may be generated according to an audio variation that matches a population segment of a first registered user, e.g., User 841, while a second alternative audio signal may be generated according to hearing preferences indicated by a second registered user, e.g., User 842. As another example, one alternative audio signal may be generated according to an audio variation that matches a first population segment of a first registered user, e.g., User 841, while a second alternative audio signal may be generated according to an audio variation that matches a second population segment of a second registered user, e.g., User 842. In another example, in case that the audience belongs to a same user segment, Processing Box 820 may adjust Audio Provider 810 according to the user segment and the modified soundtrack may be provided and played by a public device such as Audio Provider 810 to the entire audience.

In some exemplary embodiments, after the set of one or more alternative audios is generated, Audio Streamer 827 may be configured to stream each alternative audio signal to respective user devices, e.g., via a communication medium such as Auracast™, WIFI™, cellular networks, or the like. For example, User Devices 851, 852, and 853 may obtain respective variations of the movie's audio, according to hearing capabilities or preferences that were registered by Users 841, 842, and 843 via Registration Module 825. As another example, User Devices 851, 852, and 853 may obtain respective variations of the movie's audio, according to their respective user segments (potentially inferred automatically from their registered preferences, settings, or the like). In some exemplary embodiments, instead of streaming the audio signals to the user devices, Audio Streamer 827 may enable software applications of User Devices 851, 852, and 853 to access the audio signals via API calls. In other cases, Audio Streamer 827 may not be used, e.g., in case Processing Box 820 is implemented at least in part within end devices such as User Devices 851, 852, and 853, in case Audio Provider 810 is configured to produce the processed audio itself, or the like.

In some exemplary embodiments, Users 841, 842, and 843, who are registered to Processing Box 820, may obtain a processed version of the soundtrack from Audio Provider 810, e.g., to User Devices 851, 852, and 853, and from the device to their headphones, wired earplugs, wireless earplugs, Bluetooth™ headset, bone conduction headphone, electronic in-ear devices, in-ear buds, hearing aids, or the like. In some cases, the processed version of the soundtrack may be played to users via speakers of their end devices, e.g., User Devices 851, 852, and 853.

In some cases, the processed soundtrack experienced by Users 841, 842, and 843 may comprise audio that is more accessible, audible, and understandable for these users, compared to the original audio. As an example, the processed sound may correspond to personalized audio variations that are determined and/or stored for each user by Registration Module 825, may match attention disorders of each user, may match speech rates or other settings that are defined for the users' population segment, or the like.

In one example, several members of the audience may receive the same audio variation. For example, Users 841 and 842 may receive, via User Devices 851 and 852, a same audio variation because they belong to a same population segment, because they registered to receive the same audio variation, or the like, while User 843 may receive a different audio variation. In another example, Users 841 and 842 may receive, via User Devices 851 and 852, different audio variation because they belong to different population segments, because they registered to receive different audio variations, because they have different hearing capabilities, or the like.

Referring now to FIG. 8B showing exemplary hearing statistics, in accordance with some exemplary embodiments of the disclosed subject matter.

In some exemplary embodiments, different listener populations, or population segments, may have diverse needs and preferences, which may be taken into consideration when designing audio signal processing algorithms or interventions. In some exemplary embodiments, different group-related parameters may be used to predict hearing capabilities and preferences of people within such groups, e.g., according to experimental results, to gathered statistics, or the like. For example, parameters that are attributed to a specific population segment, such as age parameters, gender parameters, type of hearing disability, having a specific disorder (e.g., ADD), or the like, may enable to predict hearing capabilities of people within the specific population segment.

In some exemplary embodiments, different population segments may have different preferences regarding a ratio between audio frequencies, acoustic components, or the like, e.g., a ratio between a singer's energy level and that of the musical instruments. For example, significant reported differences between normal-hearing and hearing-impaired listeners may indicate that hearing-impaired listeners may prefer a higher energy level from the singer compared to the instruments.

In some exemplary embodiments, as depicted in FIG. 8B, the average ratio of singer voice-to-musical instruments for normal hearing listeners may be 3.83 dB, implying that normal-hearing listeners prefer to listen to songs in which the energy level of the singer is higher by 3.83 dB than that of the musical instruments. In some exemplary embodiments, as depicted in FIG. 8B, the average ratio of singer-voice-to-musical-instruments for hearing-impaired listeners may be 9.31 dB, showing that hearing-impaired listeners prefer the singer's voice to be much louder than the musical instruments. The difference between the mean ratios of these listener groups is significant (p<0.05), which exemplifies how a Singer-to-Musical Instruments Ratio parameter may be used in the EEL Module 230 (FIG. 2), or Stage 415 of FIGS. 4A-4B, as a segment-specific audio configuration.

It is noted that although the chart of FIG. 8B shows two distinct populations: normal hearing and hearing impaired, the disclosed subject matter is not limited to these populations alone, and any other categories of populations may be defined and different Singer-to-Musical Instruments Ratios may be determined therefore.

In some exemplary embodiments, different population segments may have different preferences regarding sound effects. For example, the sound effect of squeaking floorboards under the weight of a person walking on them was determined in the presence of a thunderstorm serving as background noise or background effects, e.g., in soundtracks of horror movies or in any other context. In some exemplary embodiments, in an experiment comprising listeners with ADD and a control group without ADD, the participants were asked to lower the sound level of the squeaking floorboards to the minimal audible level that still enabled perception of that sound effect in the presence of the background constant level thunderstorm. The experiment found that individuals with ADD were more sensitive to detecting such sound effects at lower SNRs (−4.23 dB) compared to a control group (an SNR of +0.62 dB, which is 4.85 dB higher). In some cases, these finding may be used for matching predetermined population segments of listeners to different acoustics needs, settings, or the like. For example, a sound effect-to-minimal SNR parameter may be used in the EEL Module 230 (FIG. 2) as a segment-specific parameter that depends on whether or not the population segments suffer from ADD.

In some exemplary embodiments, different population segments may have different preferences regarding speech rates, e.g., depending on the gender of the speaker. In some exemplary embodiments, an experiment was made with respect to the difference in perceived speech rates among three population segments of listeners: unilateral hearing-impaired, bilateral hearing-impaired, and a control group with normal hearing. The study found variations in preferred speech rates depending on the listener's condition and the gender of the speaker. For example, when listening to a male speaker, the preferred speech rate for the control group was 122 Words Per Minute (WPM), whereas the preferred speech rate for unilateral hearing-impaired was slower, 107 WPM and that of bilateral hearing-impaired was even slower, e.g., 105 WPM. When listening to a female speaker, the preferred speech rate was found to be 134 WPM, 113 WPM, and 111 WPM, respectively.

In some exemplary embodiments, different population segments may have different preferences regarding preferred speech rates, depending on the age of the population segments. For example, Table 1 depicts the Pearson correlation, Analysis of Variance (ANOVA) test result, and regression equations in the form of y=ax+b for the relationship between age and each of eight dependent speech rate variables. For example, a regression equation may represent one or more linear regression models fitted to the data for each of the eight dependent variables, in which ‘y’ represents the dependent variable, ‘x’ represents age (the independent variable), ‘a’ represents the slope of the regression line (the effect of age on the dependent variable), and ‘b’ represents the y-intercept (the value of the dependent variable when age is zero). In some cases, the eight dependent variables may measure a speech rate in the form of Phonemes Per Second (PPS), or using any other metric.

TABLE 1
Relation between age (x) and speech rate (y).

| | Pearson | | Linear |
|---|---|---|---|
| | correlation | | regression |
| Dependent Variable y (PPS) | R | ANOVA | equation |
| Maximal perceived speech rate | −0.267 | F(1, 156) = | y = |
| of a male talker without | | 11.956, | −0.26x + |
| background noise | | p < 0.001 | 12.36 |
| Maximal perceived speech rate | −0.330 | F(1, 158) = | y = |
| of a female talker without | | 19.353, | −0.35x + |
| background noise | | p < 0.001 | 13.53 |
| Maximal perceived speech rate | −0.241 | F(1, 158) = | y = |
| of a male talker in background | | 9.773, | −0.20x + |
| noise | | p = 0.002 | 11.47 |
| Maximal perceived speech rate | −0.246 | F(1, 158) = | y = |
| of a female talker in | | 10.164, | −0.22x + |
| background noise | | p = 0.002 | 11.95 |
| Preferred produced speech rate | −0.460 | F(1, 158) = | y = |
| without background noise | | 42.485, | −0.58x + |
| | | p < 0.001 | 15.60 |
| Maximal produced speech rate | −0.474 | F(1, 158) = | y = |
| without background noise | | 45.705, | −0.88x + |
| | | p < 0.001 | 21.07 |
| Preferred produced speech rate | −0.423 | F(1, 158) = | y = |
| in background noise | | 34.366, | −0.60x + |
| | | p < 0.001 | 16.04 |
| Maximal produced speech rate | −0.413 | F(1, 158) = | y = |
| in background noise | | 32.567, | −0.89x + |
| | | p < 0.001 | 21.34 |

In some exemplary embodiments, Table 1 may be used to correlate the age of each user, to an audio variant that corresponds to their age. In some cases, Table 1 may be used, e.g., by EEL Module 230 (FIG. 2), to generate different audio variations for different age ranges, which may correspond to population segments.

In some exemplary embodiments, different population segments may have different preferences, or capabilities, regarding speech intelligibility. In some exemplary embodiments, an experiment was made with respect to the difference in speech intelligibility among hearing-impaired listeners, listeners with ADD, and a control group without ADD or hearing deficiencies. The study found significant differences in word perception accuracy between the groups (F(2,49)=4.034, p=0.024), with those with ADD demonstrating lower speech intelligibility compared to the control group. Specifically, listeners with ADD perceived correctly 34% of the words while the control group perceived correctly 61% of the words (p=0.026).

In some exemplary embodiments, different population segments may have different preferences, or capabilities, regarding a dynamic range of sound levels. Table 2 depicts a dynamic range of sound levels, or sound intensities, that enables the perception whispered speech by normal-hearing participants and by bilateral hearing-impaired participants. In some exemplary embodiments, the preferred level for perceiving regular speech and the lowest level for perceiving whispered speech, for normal-hearing participants and hearing-impaired participants, are presented separately and used to calculate the dynamic range that allows one to perceive whispered speech.

| | Normal- | Bilateral Hearing- |
|---|---|---|
| Dynamic Range | Hearing | Impaired |
| Preferred level for perceiving | −14.22 dB | −10.77 dB |
| regular speech (A) | | |
| Lowest level for perceiving | −39.83 dB | −21.69 dB |
| speech as whispered (B) | | |
| Dynamic range for perceiving | −25.61 dB | −10.92 dB |
| whispered speech (B − A) | | |

In some exemplary embodiments, as can be inferred from Table 2, the dynamic range of bilateral hearing impaired for perceiving speech as whispered and not as a regular speech is 10.92 dB whereas that for normal hearing is 25.61 dB. In some cases, when preparing audio soundtracks, this may be taken into consideration, such as in order to make the audio accessible and audible for bilateral hearing impaired. In some cases, mixing such soundtracks may result in an improved listening experience for the hearing-impaired. In some cases, EEL Module 230 (FIG. 2) may implement such a technique when preparing audio soundtracks, or take the dynamic ranges into consideration in any other way.

In some exemplary embodiments, a multiple regression model may be generated based on insights derived from the results of the experiments. For example, the multiple regression model may be developed to predict the preferred listening speech rate of an individual based on various input variables, including age, hearing status (normal-hearing or hearing-impaired), presence of ADD, preferred sound levels, and signal-to-noise ratios.

In some exemplary embodiments, the model may be trained to predict the preferred listening speech rate (in WPM metric, PPS metric, or any other metric) of an end-user α. Model correlation coefficients are R=0.559, R square=0.313, and adjusted R square=0.261). For example, Equation 3 below describes that the model prediction is based on an input of a variable set, vᵢ, and a derived coefficient set, cᵢ, described in Table 3 below. In some cases, the Variable set, vᵢ, may pertain to the end-user α and may be obtained from the end-user α by completing an interactive questionnaire in a dedicated software application, indirectly by monitoring activities of the end user α, indirectly from a third-party source, from a database of user profiles, or the like.

$$W P M = {c}_{0} + {\sum }_{i = 1}^{n} {c}_{i} \cdot {v}_{i} ( α ) \qquad ( 3 )$$

In some exemplary embodiments, Table 3 depicts, for input variables vᵢ, and coefficients cᵢ, a multiple regression model for predicting the preferred listening rate of an end-user (e.g., according to Equation 3).

| Index | vᵢ (units) | Variable description | cᵢ |
|---|---|---|---|
| 0 | | | 132.78 |
| 1 | Age (yrs.) | End-user's age | −0.138 |
| 2 | NH or HI | Is the end-user normal-hearing or | −1.07 |
| | (dichotomous) | Hearing-Impaired (0, 1) | |
| 3 | ADD or not | Is the end-user diagnosed with ADD or | −3.167 |
| | (dichotomous) | not (0, 1) | |
| 4 | Lₘ | Preferred sound level while listening to | −0.653 |
| | (0-100 scale) | the male talker in background noise | |
| 5 | L_{whisper} | Maximal background noise level | −15.142 |
| | (0-100 scale) | allowing perceiving whispered speech | |
| 6 | SNRₘ | Average Signal-to-Noise Ratio for | −0.468 |
| | (unitless) | perceiving male talker | |
| 7 | SNR_{songs} | Average Song level to musical | −0.259 |
| | (unitless) | instruments level preferred by the end | |
| | | user | |
| 8 | SNR_{sound effect} | Average Sound effect to background | −0.338 |
| | (unitless) | ratio by the end user | |

As depicted in Table 3, an individual's preferred listening rate may be influenced by various factors, such as the key variables and coefficients used in the multiple regression model.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method comprising:
capturing an audio signal from an audio source;
processing the audio signal based on a population segment, said processing comprises:
obtaining a target speech rate for the population segment, the target speech rate is a rate of speech that is deemed suitable to estimated hearing capabilities of members of the population segment; and
adjusting the audio signal according to the target speech rate for the population segment, thereby obtaining an adjusted audio signal that matches the hearing capabilities of the population segment; and
providing the adjusted audio signal to an end device to be served to a user, wherein the population segment comprises the user, the user is using the end device to consume audio.

2. The method of claim 1, wherein said processing further comprises separating the audio signal into a plurality of acoustic components, wherein the plurality of acoustic components comprises at least two of: a speech component, a music component, and a sound effect component.

3. The method of claim 2, wherein said adjusting comprises adjusting the speech component according to the target speech rate.

4. The method of claim 2, wherein said processing further comprises:
balancing weights of the plurality of acoustic components according to preferences of the population segment, thereby obtaining the adjusted audio signal.

5. The method of claim 4, wherein the preferences are associated with at least one of: a vocals-to-non-vocals ratio, a dynamic loudness range, and a level of attenuation of background noise.

6. The method of claim 1, wherein said adjusting is performed with a first time-lag threshold if said processing comprises offline processing, and with a second time-lag threshold if said processing comprises real-time processing, the first and second time-lag thresholds are different.

7. The method of claim 1 further comprising reducing a latency created by said adjusting the audio signal according to the target speech rate, wherein said reducing the latency comprises at least one of: accelerating a pace of a first non-speech segment of the audio signal, and removing a second non-speech segment of the audio signal.

8. The method of claim 1, wherein the target speech rate is slower than an original speech rate of the audio signal.

9. The method of claim 1, wherein said processing further comprises classifying content of the audio signal to an auditory scene, wherein the auditory scene comprises at least one of: a conversation, a lecture, a defined movie scene, music, a live performance, aircraft sounds, construction sounds, nature sounds, train sounds, and vehicle sounds.

10. The method of claim 9, wherein said adjusting is performed based on the auditory scene, wherein the target speech rate for the population segment is configured to match the hearing capabilities of the population segment for the auditory scene.

11. The method of claim 1, wherein said capturing the audio signal comprises receiving the audio signal from a console or a mixer associated with the audio source.

12. The method of claim 1, wherein said capturing the audio signal comprises recording a sound produced by the audio source.

13. The method of claim 1 further comprising classifying the user to the population segment.

14. The method of claim 13, wherein said classifying is based on demographic information of the user, the demographic information comprising at least one of: an age range, a type of hearing impairment, a gender, a cognitive state, and an attention disorder.

15. The method of claim 14, wherein the demographic information is provided by the user via a user interface of a dedicated software application presented on the end device.

16. The method of claim 14, wherein the demographic information is determined indirectly based on data of the end device.

17. The method of claim 1, wherein said providing the adjusted audio signal is performed via Application Programming Interface (API) calls of a third-party software application executed on the end device.

18. The method of claim 1, wherein said providing the adjusted audio signal is performed via a communication medium selected from: Low Energy (LE)-audio, long range wireless communications, Infrared communications, Type-C communications, Bluetooth™, Auracast™, short range wireless communications, Lightning™, cellular communications, wired communications, and WIFI™.

19. The method of claim 1, wherein the audio source comprises an audio source of at least one of: a cinema, a theater, a television, and a person participating in a conversation with the user.

20. The method of claim 1, wherein the end device comprises at least one device selected from: a smartphone, a smart television, a mobile device, a laptop, hearables, Personal Computer (PC), wearables, and a tablet.

21. The method of claim 1, wherein said processing is performed at least in part by at least one of: a central processing unit, and the end device.

22. The method of claim 1, wherein the method is performed in an environment, wherein the user is present in the environment, wherein the user is using the end device to consume audio in the environment, wherein said capturing comprises capturing the audio signal in the environment.

23. A computer program product comprising a non-transitory computer readable storage medium retaining program instructions, which program instructions when read by a processor, cause the processor to:
capture an audio signal from an audio source;
process the audio signal based on a population segment, said process comprises:
obtain a target speech rate for the population segment, the target speech rate is a rate of speech that is deemed suitable to estimated hearing capabilities of members of the population segment; and
adjust the audio signal according to the target speech rate for the population segment, thereby obtaining an adjusted audio signal that matches the hearing capabilities of the population segment; and
provide the adjusted audio signal to an end device to be served to a user, wherein the population segment comprises the user, the user is using the end device to consume audio.

24. The computer program product of claim 23, wherein the program instructions, when read by the processor, cause the processor to process the audio signal based on a second population segment, the second population segment comprises a second user with a second end device, said process comprises:
obtaining a second speech rate for the second population segment, the second speech rate is a rate of speech that is deemed suitable to estimated hearing capabilities of members of the second population segment;
adjusting the audio signal according to the second speech rate for the second population segment, thereby obtaining a second adjusted audio signal that matches the hearing capabilities of the second population segment; and
providing the second adjusted audio signal to the second end device, to be served to the second user.

25. A system comprising a processor, an audio source, and coupled memory, the processor being adapted to:
capture an audio signal from the audio source;
process the audio signal based on a population segment, said process comprises:
obtain a target speech rate for the population segment, the target speech rate is a rate of speech that is deemed suitable to estimated hearing capabilities of members of the population segment; and
adjust the audio signal according to the target speech rate for the population segment, thereby obtaining an adjusted audio signal that matches the hearing capabilities of the population segment; and
provide the adjusted audio signal to an end device to be served to a user, wherein the population segment comprises the user, the user is using the end device to consume audio.
